(19) United States
(12) Patent Application Publication
(10) Pub. No.: US 2026/0355673 A1
(43) Pub. Date: Nov. 12, 2026

(54) VACUUM CHAMBER WITH DUAL PURPOSE INTERNAL STRUCTURE

(71) Applicant: Provocative Science Holdings, Inc., Somerville, MA (US)

(72) Inventors: Bryan Woodruff, Medford, MA (US); Andrew Bouma, Cambridge, MA (US)

(73) Assignee: Provocative Science Holdings, Inc., Somerville, MA (US)

(21) Appl. No.: 19/674,984

(22) Filed: May 12, 2026

Related U.S. Application Data
(60) Provisional application No. 63/804,308, filed on May 12, 2025.

(51) Int. Cl. B01D 53/04

(52) U.S. Cl. CPC B01D 53/0446; B01D 53/0462; B01D 2257/504

(57) ABSTRACT

A vacuum chamber with dual-purpose internal structure. The vacuum chamber comprises at least an exterior wall defining an interior of the vacuum chamber, a selectively sealable air intake coupled to the exterior wall and in fluid communication with the interior of the vacuum chamber, a selectively sealable air exhaust coupled to the exterior wall and in fluid communication with the interior of the vacuum chamber, at least a vacuum pump in communication with the vacuum chamber, a first element of one or more airborne element capture material disposed within the vacuum chamber, wherein the first element fills the vacuum chamber in a first direction, a second element of one or more hollow structural sections disposed within the vacuum chamber, wherein the second element fills the vacuum chamber in a second direction.

### CROSS-REFERENCE TO RELATED APPLICATIONS

This application claims the benefit of priority of U.S. Provisional Patent Application Serial No. 63/804,308, filed on May 12, 2025, and titled “VACUUM CHAMBER WITH DUAL PURPOSE INTERNAL STRUCTURE,” which is incorporated by reference herein in its entirety.

### FIELD OF THE INVENTION

The present invention generally relates to the field of airborne element capture. In particular, the present invention is directed to a vacuum chamber with dual purpose internal structure.

### BACKGROUND

Airborne element capture technologies can capture airborne element at the source or directly from air, enabling it to be either reused for industrial or consumer applications or serve to purify the environment. Current systems used to capture airborne elements are inefficient in terms of chamber architecture and internal design.

### SUMMARY OF THE DISCLOSURE

In an aspect, a vacuum chamber with dual-purpose internal structure, the vacuum chamber comprising at least an exterior wall defining an interior of the vacuum chamber, a selectively sealable air intake coupled to the exterior wall and in fluid communication with the interior of the vacuum chamber, a selectively sealable air exhaust coupled to the exterior wall and in fluid communication with the interior of the vacuum chamber, at least a vacuum pump in communication with the vacuum chamber, a first element of one or more airborne element capture material disposed within the vacuum chamber, wherein the first element fills the vacuum chamber in a first direction, a second element of one or more hollow structural sections disposed within the vacuum chamber, wherein the second element fills the vacuum chamber in a second direction.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an exemplary embodiment of a vacuum chamber with dual purpose internal structure;

FIG. 2 is an example embodiment of a cross-sectional view of a carbon capture chamber;

FIG. 3 is an example embodiment of a front view of a carbon capture chamber;

FIG. 4 is an example embodiment of a cross-sectional view taken along a horizontal plane of a carbon capture chamber;

FIG. 5 is an example embodiment of a cross-sectional view taken along a vertical plane of a carbon capture chamber; and

FIG. 6 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems for a vacuum chamber with dual purpose internal structure. In an aspect, conventional vacuum chamber may require substantial structural reinforcement to maintain their integrity under vacuum conditions. Such chambers are often constructed with thick sidewalls, reinforcing ribs and/or particular geometric shapes (e.g., cylindrical) to withstand vacuum pressures. Consequently, conventional vacuum chambers tend to be expensive to produce, requiring a significant amount of material and complex manufacturing processes. To address these issues, embodiments presented in present disclosure provide a vacuum chamber with dual purpose internal structure configured to improve the simplicity and efficiency of mass production, thereby reducing the cost of manufacturing. In one or more embodiments, the vacuum chamber is configured to have one or more airborne element capture material disposed within the vacuum chamber in a first direction and have one or more hollow structural sections disposed within the vacuum chamber in a second direction. One or more airborne element capture materials may be configured to both capture desired airborne element product and provide structural support to the chamber. One or more hollow structural sections may include thermal conductive materials while providing structural support to the chamber. In another aspect, the present disclosure includes a vacuum chamber configured to capture airborne elements and maintain structural integrity of the whole system by counteracting atmospheric forces.

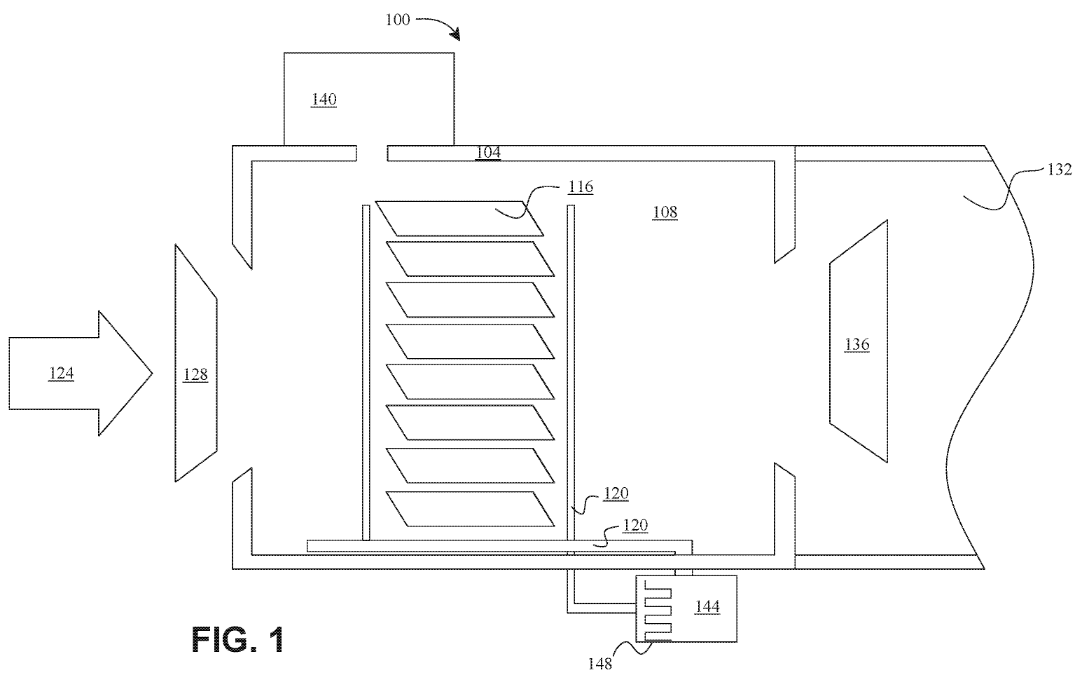

Referring now to FIG. 1, an exemplary embodiment of vacuum chamber with dual-purpose internal structure is illustrated, herein also referred to as “chamber” or “vacuum chamber.” Vacuum chamber with dual-purpose internal structure may use external energy to actively capture CO₂ and remove CO₂ from the air. In one or more embodiments, a carbon capture system may include passive solutions, such as biochar, for CO₂ sequestration. Active carbon capture systems may actively flow air to an adsorbent material and actively remove carbon from the surrounding air. In one or more embodiments, an active carbon capture system may use fans and/or already existing infrastructure to divert flowing air to a chamber 100, wherein CO₂ may be actively removed from the surrounding air. In one or more embodiments, an active carbon capture system may rely on chemical adsorption or direct air capture using fans and sorbents. In one or more embodiments, an active carbon capture system may rely on external forces to direct air through the carbon capture system and forcibly remove carbon from the surrounding air. Chamber 100 may be incorporated in and/or otherwise combined with a carbon capture system as disclosed in U.S. Nonprovisional Application No. 19/204,954, filed on May 12, 2025, with attorney docket number 1706-001USU1 and entitled “CARBON CAPTURE SYSTEMS AND METHODS OF USE,” the entirety of which is incorporated herein by reference.

In one non-limiting example, the term “dual-purpose internal structure” may refer to an internal structure within the vacuum chamber that is configured to perform at least two distinct functions, such as (i) facilitating the capture and adsorption of CO₂ from an airflow and (ii) structurally supporting, directing, or conditioning that airflow within the chamber to improve contact between the air and an adsorbent material. For instance, the internal structure may include features such as channels, baffles, or porous supports that both hold or position a sorbent medium and also guide or regulate airflow to increase residence time and surface interaction. In another non-limiting example, the internal structure may additionally serve both a capture function and a regeneration or release function, such as enabling heating, pressure variation, or other conditions that allow captured CO₂ to be subsequently released for collection or sequestration.

In one non-limiting example, such a dual-purpose internal structure may provide advantages over single-purpose designs by reducing system complexity, minimizing the number of separate components, and improving overall efficiency of the carbon capture process. For example, without limitation, integrating airflow management and sorbent support into a single structure may increase CO₂ capture efficiency by ensuring more uniform air distribution and enhanced contact with the adsorbent material, while also reducing pressure losses and energy consumption associated with moving air through the system. Additionally, the dual-purpose configuration may enable more compact system designs, easier integration with existing infrastructure, and improved scalability, as fewer discrete elements are required to achieve both airflow conditioning and carbon capture functionality. These improvements may contribute to more effective and economically viable active carbon capture systems.

With continued reference to FIG. 1, chamber 100 is configured with at least an exterior wall 104 that is used to provide a structure for chamber 100. In one or more embodiments, at least an exterior wall 104 may ensure that chamber 100 can provide a sealed environment from the atmosphere. In one or more embodiments, at least an exterior wall 104 may provide structural rigidity such that chamber 100 does not collapse or buckle under negative pressure conditions. In one or more embodiments, chamber 100 may be similar in form to a container, wherein at least an exterior wall 104 defines the structure boundary of the container. In one or more embodiments, at least an exterior wall 104 may be made of thermally conductive materials to facilitate a heat transfer between an inside of chamber 100 and an outside of chamber 100. An interior 108 of chamber 100 is defined by the structure and spatial arrangement of the exterior walls 104 configuration.

In one or more embodiments, when at least a vacuum pump 140 of the chamber 100 may be turned on, vacuum conditions may be generated within the interior 108 of the chamber 100. Under such conditions, at least an exterior wall 104 may be drawn inward into structural contact with internal components of the chamber 100, including but not limited to one or more airborne element capture material 116 and one or more structural sections 120, as will be described in further detail below. Such a contract may provide additional structural support to the chamber 100. In one or more embodiments, when at least a vacuum pump 140 may be turned off and atmospheric pressure conditions may be present within the interior 108 of the chamber 100, at least an exterior wall 104 may either be drawn inward into structural contact with internal components of the chamber 100 or remain positioned within a gap between the internal components of the chamber 100. As used in this disclosure, "vacuum conditions" is a state within an enclosed volume in which internal pressure is below ambient atmospheric pressure such that a pressure differential induces an inward-directed force on one or more structural boundaries. In an embodiment, vacuum conditions may be generated by activating a vacuum pump to reduce pressure within an interior of a chamber, thereby causing an exterior wall to be drawn into contact with one or more airborne element capture material and one or more hollow structural sections. In a non-limiting example, vacuum conditions may include partial vacuum levels that are sufficient to induce structural engagement between internal components and chamber walls without requiring a near-total vacuum, thereby enabling structural reinforcement while maintaining operational efficiency. For example, without limitation, vacuum conditions may be dynamically adjusted during operation to control the degree of wall deflection, contact force, and structural load transfer between internal supports and exterior boundaries, and the like. In an embodiment, when the vacuum pump generates vacuum conditions within the vacuum chamber interior, the exterior wall is configured to draw inward and engage with the one or more airborne element capture material and the one or more hollow structural sections. In an embodiment, when the vacuum pump generates vacuum conditions within the vacuum chamber interior, the vacuum pump may be actuated by a control circuit that regulates operation based on sensed pressure levels, timing sequences, or external commands, thereby initiating a pressure reduction process within the interior volume of the chamber. The reduction in internal pressure relative to ambient atmospheric pressure may create a pressure differential across the exterior wall, wherein the higher external pressure applies a distributed force along the exterior wall surface, causing the exterior wall to deform inward toward internal components. In one or more embodiments, the exterior wall may be formed from a material and thickness selected to permit controlled inward displacement under such pressure differentials while maintaining sealing integrity and avoiding material failure. As the exterior wall moves inward, the exterior wall may progressively approach and contact the one or more airborne element capture material and the one or more hollow structural sections, which may be arranged within the chamber in orthogonal or otherwise complementary orientations. In one or more embodiments, the one or more airborne element capture material may include layered, stacked, or modular structures that extend across a first direction within the chamber, while the one or more hollow structural sections may extend along a second direction, thereby forming an internal framework. The inward movement of the exterior wall may result in mechanical engagement with surfaces of these internal components, wherein contact forces may be distributed across multiple contact points. In one or more embodiments, such engagement may include surface-to-surface contact, line contact, or point contact depending on the geometry and arrangement of the internal components. The exterior wall may conform to contours defined by the one or more airborne element capture material and the one or more hollow structural sections, thereby transferring loads from the exterior wall into the internal framework. In one or more embodiments, the internal components may resist deformation due to their material properties, geometry, and orientation, thereby counteracting inward forces applied by atmospheric pressure. In one or more embodiments, the engagement between the exterior wall and the internal components may occur dynamically as vacuum conditions are increased or decreased, allowing the chamber to transition between different structural states. For example, without limitation, increasing vacuum levels may increase contact force and the number of engagement points, while decreasing vacuum levels may reduce contact force and permit partial disengagement. In one or more embodiments, the system may operate in repeated cycles in which vacuum conditions are generated and released, and the exterior wall correspondingly moves inward and outward in response to changing pressure conditions. In one or more embodiments, the vacuum pump may be fluidly connected to the chamber through conduits, valves, and seals that enable controlled extraction of gases from the interior. The extracted gases may be routed through exhaust pathways, filtration systems, or downstream processing units. The control circuit may coordinate operation of the vacuum pump with other subsystems, including airflow control components, temperature control systems, and monitoring sensors, to achieve desired operational states. Sensors may include pressure sensors, temperature sensors, strain gauges, or position sensors configured to detect movement or deformation of the exterior wall. In one or more embodiments, the chamber may be implemented in a variety of environments, including industrial carbon capture systems, building-integrated ventilation systems, data center airflow systems, or modular capture units deployed in distributed networks. The system may operate in real-time to continuously process airflow or in batch modes where discrete volumes of gas are processed sequentially. Users may include facility operators, environmental engineers, or automated control systems that manage large-scale capture operations. In one or more embodiments, the described configuration may provide advantages including reduced material requirements for exterior walls, improved scalability of chamber size, enhanced load distribution across internal structures, and increased efficiency in manufacturing and operation. The coordinated interaction between pressure differentials, exterior wall movement, and internal structural engagement may enable a lightweight yet robust chamber design capable of withstanding repeated vacuum cycles without structural failure.

With continued reference to FIG. 1, chamber 100 may be configured in different shapes along its longitudinal and transverse axes. In one or more embodiments, the chamber 100 may have a uniform cross-sectional shape along the longitudinal axes. In one or more embodiments, chamber 100 may have a uniform cross-sectional shape along the transverse axes. In one or more embodiments, chamber 100 may have a varied transverse and/or longitudinal cross section, shaped along its longitudinal or transverse axes, respectively. In one or more embodiments, chamber 100 may be made of any combination of curved and/or polygonal geometry. The cross-sectional profile of the chamber 100 may include substantially rectangular forms corresponding to a substantially rectangular prism structure and/or substantially circular or elliptical forms corresponding to substantially cylindrical or lozenge-like structures.

With continued reference to FIG. 1, at least an exterior wall 104 of chamber 100 may be formed from various materials selected to provide structural integrity, thermal performance, or chemical resistance. In one or more embodiments, at least an exterior wall 104 may be formed from rigid materials, such as metals, including, but not limited to, stainless steel or aluminum or a combination thereof. In one or more embodiments, at least an exterior wall 104 of chamber 100 may be formed from flexible materials, such as polymeric or plastic materials. Suitable flexible materials may include, but are not limited to, high-density polyethylene (HDPE), low-density polyethylene (LDPE), linear low-density polyethylene (LLDPE), polypropylene (PP), or a combination of HDPE and LLDPE. In one or more embodiments, the flexible nature of at least an exterior wall 104 may allow the chamber 100 to dynamically conform to the volume, arrangement, or profile of internal components disposed within the chamber 100. For example, without limitation, internal components (e.g., one or more airborne element capture material 116 or one or more structural sections 120) may be stacked or arranged within the chamber 100, at least an exterior wall 104 may be shaped outward or inward based on the degree of internal filling, thereby allowing the overall geometry of the chamber 100 to adapt to its contents. Such a feature may provide benefits in storage, transport, or modularity by enabling reconfigurable internal volumes while maintaining a sealed environment.

With continued reference to FIG. 1, the ends of chamber 100 may be reinforced to enhance structural strength, sealing performance, or support external interfacing. In one or more embodiments, reinforcement materials may include metals such as stainless steel or anodized aluminum. In one or more embodiments, non-metallic materials such as fiberglass-reinforced plastic (FRP), carbon fiber composites, or thermoset epoxy resins may also be used for end reinforcement. In one or more embodiments, reinforcement materials may be integrated into the chamber 100 structure. In one or more embodiments, reinforcement materials may be removable from the chamber 100 structure. In one or more embodiments, reinforcement materials may serve as structural interfaces for mounting, transport, or connection to ancillary components.

With continued reference to FIG. 1, chamber 100 may include a selectively sealable air intake 124. Selectively sealable air intake 124 may be configured to receive gas, such as, without limitation, air into chamber 100. As used in this disclosure, an “air intake” is any device, opening, or component configured to facilitate the entry of air into a system, such as into chamber 100, including structures that draw, direct, or regulate incoming air prior to or during processing. An air intake may be configured to introduce ambient air into the system so that desired airborne elements or particulates, such as CO₂, may be captured, filtered, or otherwise processed within the chamber. In one or more embodiments, an air intake may include a fan configured to actively draw external air into an enclosed space. In one or more embodiments, an air intake may include a duct, channel, or inlet port that directs airflow from an external environment into chamber 100. In one or more embodiments, an air intake may include an inlet valve configured to regulate the volume, pressure, or rate of air entering the chamber. In one or more embodiments, the inlet valve may be selectively sealable to prevent air from entering when in a closed position, such as during vacuum conditions or controlled processing cycles. In one or more embodiments, an air intake may further include a filtration component positioned upstream of chamber 100 to remove particulates prior to entry. In one or more embodiments, an air intake may include controllable elements, such as dampers, motors, or solenoid valves, that are configured to modulate airflow based on system conditions. In one or more embodiments, such components may be operatively coupled to a control circuit to enable automated regulation of incoming air. In one or more embodiments, a selectively sealable air intake 124 may include a turbine or other device functioning as an impeller, configured to cause air to flow into chamber 100. In one or more embodiments, a selectively sealable air intake 124 may include a fan and/or any other devices configured to provide for air to flow into chamber 100. In one or more embodiments, a selectively sealable air intake 124 may include air intake ducts. In one or more embodiments, a selectively sealable air intake 124 may include large ducts or openings designed to pull in ambient air. In one or more embodiments, a selectively sealable air intake 124 may include protective covers, such as grilles and/or mesh in order to prevent and/or minimize debris from entering chamber 100. In one or more embodiments, a selectively sealable air intake 124 may include filters that only allow air to enter chamber 100 while removing dust, particulates, and/or objects. In one or more embodiments, a selectively sealable air intake 124 may include filters and/or fans to ensure a steady flow of air into chamber 100. In one or more embodiments, a selectively sealable air intake 124 includes intake valve 128 in order to regulate the volume of air entering chamber 100. In one or more embodiments, a selectively sealable air intake 124 may be configured to prevent external air from entering when the intake valve 128 is in a closed position. In one or more embodiments, a sealing mechanism, such as a hinged lid or a threaded cap, may be coupled with the intake valve 128 to form an airtight seal when closed. In one or more embodiments, the intake valve 128 is sealable via a sliding gate valve that includes an elastomeric seal. In one or more embodiments, an intake valve 128 may be used to control the direction of gas. In one or more embodiments, air may flow into one or more portions of chamber 100. In one or more embodiments, the intake valve 128 may include motors and/or solenoid valves that are configured to control a flow of air into chamber 100. In one or more embodiments, intake valve 128 may be controlled using a control circuit as described in further detail below.

With continued reference to FIG. 1, the selectively sealable air intake may include an intake valve configured to regulate an amount of air entering the vacuum chamber and control a direction of an inlet fluid, wherein the inlet fluid comprises a gas. As used in this disclosure, "inlet fluid" is a substance in a fluid state that is introduced into a system through an inlet or intake interface. In an embodiment, the inlet fluid may include atmospheric air directed into a vacuum chamber through a selectively sealable air intake for processing within the chamber. In a non-limiting example, the inlet fluid may include a mixture of gases such as carbon dioxide, nitrogen, oxygen, water vapor, and the like. Without limitation, the inlet fluid may be conditioned prior to entry by filtration, temperature adjustment, pressure regulation, or flow control, and the like. As used in this disclosure, "gas" is a state of matter characterized by particles that have neither a fixed shape nor a fixed volume and that expand to fill an available space. In an embodiment, the gas may include ambient air introduced into a vacuum chamber for purposes of airborne element capture or processing. In a non-limiting example, the gas may include one or more components such as carbon dioxide, methane, ammonia, volatile organic compounds, and the like. Continuing the previous non-limiting example, the gas may be selectively directed, pressurized, or evacuated within the vacuum chamber using valves, pumps, and flow control systems, and the like. In one or more embodiments, the intake valve may include a mechanically actuated or electronically controlled flow regulation component that adjusts an opening size, position, or orientation of a flow passage to control volumetric flow rate of the inlet fluid entering the vacuum chamber. In one or more embodiments, the intake valve may be coupled to a control circuit including a processor and memory that execute instructions to dynamically regulate flow based on sensor inputs such as pressure, temperature, flow rate, or composition of the inlet fluid. In one or more embodiments, the inlet fluid may be received through multiple pathways, including ducted airflow systems, external piping, or distributed intake ports, wherein the intake valve may selectively open, close, or modulate flow across one or more pathways. In one or more embodiments, control of direction of the inlet fluid may include routing the inlet fluid toward specific regions of the vacuum chamber, including toward one or more airborne element capture material or along predefined flow channels formed by internal structures such as fins or hollow structural sections. In one or more embodiments, the intake valve may operate in coordination with other system components including vacuum pumps, exhaust valves, and temperature control systems to maintain desired operating conditions within the vacuum chamber. For example, without limitation, the intake valve may restrict or permit inflow in response to activation of the vacuum pump to maintain target pressure levels while ensuring sufficient exposure of the inlet fluid to capture materials. In one or more embodiments, the intake valve may be controlled in real time or according to predetermined schedules, enabling operation in continuous flow modes, batch processing modes, or adaptive control modes based on system demand. In one or more embodiments, the inlet fluid may be processed through upstream or downstream systems including filtration units, compressors, or heat exchangers prior to or after entering the vacuum chamber. The intake valve may interface with such systems via communication protocols and control signals transmitted across wired or wireless networks, enabling coordinated operation across distributed system architectures. In one or more embodiments, the system may be deployed in industrial facilities, building ventilation systems, or modular carbon capture installations operating in cloud-connected or edge-controlled environments, thereby allowing remote monitoring, automation, and optimization of inlet fluid handling and chamber performance.

With continued reference to FIG. 1, a selectively sealable air exhaust 132 may be configured to remove unwanted gas, such as air that has already passed over and/or through carbon capture components. An “air exhaust” for the purpose of this disclosure refers to any device or component that facilitates the removal of unwanted air. In an embodiment, the air exhaust may include a shaft or opening through which air from which desired airborne elements or particulates has been captured can escape. For example, and without limitation, an air conditioning unit may contain an exhaust system that removes heated air that was initially used to cool down components of the air conditioning unit. In one or more embodiments, a selectively sealable air exhaust 132 may include a fan configured to remove unwanted air or gases from within an enclosed space. In one or more embodiments, a selectively sealable air exhaust 132 may include a duct that allows for unwanted air or gases to be removed from a particular system. In one or more embodiments, a selectively sealable air exhaust 132 includes outlet valve 136 in order to regulate the volume of air in existing chamber 100. In one or more embodiments, a selectively sealable air exhaust 132 may be configured to prevent internal air from exiting when the outlet valve 136 is in a closed position. In one or more embodiments, a sealing mechanism, such as a hinged lid or a threaded cap, may be coupled with the outlet valve 136 to form an airtight seal when closed. In one or more embodiments, the outlet valve 136 is sealable via a sliding gate valve that includes an elastomeric seal. In one or more embodiments, an outlet valve 136 may include motors and/or solenoid valves that are configured to control a flow of air exiting chamber 100. In one or more embodiments, an outlet valve 136 may be controlled using a control circuit as described in further detail below.

With continued reference to FIG. 1, as used in this disclosure, a “valve” is a component that controls fluidic communication between two or more components. Exemplary non-limiting valves include directional valves, control valves, selector valves, multi-port valves, check valves, and the like. Valves may include any suitable valve construction, including ball valves, butterfly valves, needle valves, globe valves, gate valves, wafer valves, regulator valves, and the like. Valves may be included in a manifold of hydraulic or pneumatic circuits, for example, allowing for multiple ports and flow paths. Valves may be actuated by any known method, such as, without limitation, by way of hydraulic, pneumatic, mechanical, or electrical energy. For instance, in some cases, a valve may be actuated by an energized solenoid or electric motor. Valve actuators and thereby valves themselves may be controlled by a computing device.

With continued reference to FIG. 1, chamber 100 may include a control circuit. Control circuit may include any analog and/or digital components configured or assembled to perform functions as described below. Control circuit may include, without limitation, an operational amplifier circuit, a combinational logic circuit, and/or a sequential logic circuit. Control circuit may include circuitry, such as, without limitation, a processor communicatively connected to a memory; for instance, circuitry may include and/or be included in a computing device. As used in this disclosure, “communicatively connected” means connected by way of a connection, attachment, or linkage between two or more relata, such as, without limitation, electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, memory may include a primary memory and a secondary memory. “Primary memory” also known as “random access memory” (RAM) for the purposes of this disclosure is a short-term storage device in which information is processed. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power. “Secondary memory” also known as “storage,” “hard disk drive” and the like for the purposes of this disclosure is a long-term storage device in which an operating system and other information is stored. In one or remote embodiments, information may be retrieved from secondary memory and transmitted to primary memory during use. In one or more embodiments, secondary memory may be referred to as non-volatile memory wherein information is preserved even during a loss of power. In one or more embodiments, data within secondary memory cannot be accessed by processor. In one or more embodiments, data is transferred from secondary to primary memory wherein circuitry may access the information from primary memory.

Control circuit may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

Further referring to FIG. 1, control circuit may include any computing device as described in this disclosure, including without limitation a microcontroller, microprocessor, digital signal processor (DSP) and/or system on a chip (SoC) as described in this disclosure. Control circuit may include, be included in, and/or communicate with a mobile device such as a mobile telephone or smartphone. Control circuit may include a single computing device operating independently, or may include two or more computing device operating in concert, in parallel, sequentially or the like; two or more computing devices may be included together in a single computing device or in two or more computing devices. Control circuit may interface or communicate with one or more additional devices as described below in further detail via a network interface device. Network interface device may be utilized for connecting control circuit to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Control circuit may include but is not limited to, for example, a computing device or cluster of computing devices in a first location and a second computing device or cluster of computing devices in a second location. Control circuit may include one or more computing devices dedicated to data storage, security, distribution of traffic for load balancing, and the like. Control circuit may distribute one or more computing tasks as described below across a plurality of computing devices of computing device, which may operate in parallel, in series, redundantly, or in any other manner used for distribution of tasks or memory between computing devices. Control circuit may be implemented, as a non-limiting example, using a “shared nothing” architecture.

With continued reference to FIG. 1, control circuit may be designed and/or configured to perform any method, method step, or sequence of method steps in any embodiment described in this disclosure, in any order and with any degree of repetition. For instance, control circuit may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Control circuit may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, chamber 100 may be configured to include at least a vacuum pump 140. A “vacuum pump,” for the purpose of this disclosure, refers to one or more vacuum pumps that are used to extract substances from a chamber. At least a vacuum pump 140 may be in communication with chamber 100. In one or more embodiments, at least a vacuum pump 140 may include an input port that is directly connected to the interior 108 of the chamber 100. In one or more embodiments, the input port may be configured as a vacuum hose or a flange connection. In one or more embodiments, the connection between the vacuum pump and the chamber 100 may form a tight seal to prevent ambient air from entering chamber 100 during vacuum operation. At least a vacuum pump 140 may include a waste gas outlet that releases air to the outside environment and a carbon dioxide outlet in communication with the temperature control system 144, configured to connect to a carbon dioxide collection system. In one or more embodiments, the waste gas outlet may be integrated with a selectively sealable air exhaust, such as both components share a common vent or duct through which air is expelled from the chamber 100. In one or more embodiments, the waste gas outlet may be implemented as a separate and independent venting system distinct from a selectively salable air exhaust. In one or more embodiments, at least a vacuum pump may be in communication with the vacuum chamber via a fluid pathway that enables removal of gases from an interior volume of the vacuum chamber. The fluid pathway may include one or more conduits, ducts, hoses, or channels that establish a sealed or selectively sealable connection between an inlet of the vacuum pump and the interior of the vacuum chamber. In one or more embodiments, the connection may include a flange interface, threaded coupling, compression fitting, or welded joint configured to maintain an airtight seal during operation. In one or more embodiments, at least a vacuum pump may be directly coupled to the vacuum chamber such that an inlet port of the vacuum pump is positioned in immediate fluid communication with the interior volume. In another non-limiting example, at least a vacuum pump may be remotely positioned and connected through one or more intermediate conduits, wherein the conduits may include valves, flow regulators, or filters configured to control flow characteristics between the vacuum chamber and the vacuum pump. In one or more embodiments, communication between at least a vacuum pump and the vacuum chamber may further include control communication, wherein a control circuit may regulate operation of the vacuum pump based on pressure conditions within the vacuum chamber. The control circuit may include one or more processors, memory components, and control logic configured to activate, deactivate, or modulate the vacuum pump in response to sensor data, including pressure sensors, flow sensors, or temperature sensors disposed within or adjacent to the vacuum chamber. In one or more embodiments, at least a vacuum pump may include multiple stages or multiple pumps arranged in series or parallel, wherein each pump is in communication with the vacuum chamber through a shared or distributed manifold system. The manifold system may distribute fluid flow across multiple pump inlets and may include isolation valves that allow selective engagement or disengagement of individual pumps. In one or more embodiments, such configurations may enable staged vacuum generation, redundancy, or load balancing across the system. In one or more embodiments, communication between at least a vacuum pump and the vacuum chamber may include integration with downstream systems, wherein extracted gases are directed through exhaust lines to storage systems, filtration systems, or processing units. The vacuum pump may therefore operate as part of a broader network of components that collectively manage gas extraction, transport, and processing within the system. With continued reference to FIG. 1, chamber 100 is configured to include one or more airborne element capture material 116. A “airborne element capture material," as used in this disclosure, is a type of material that is designed to trap desired airborne elements from an airstream or enclosed atmosphere. In one or more embodiments, one or more airborne element capture material 116 may be disposed of chamber 100 in a stacked, layered, packed, or modular arrangement. In one or more embodiments, one or more airborne element capture material 116 may be selected based on the type of element or contaminant targeted for removal. In one or more embodiments, one or more airborne element capture material 116 may be configured to selectively capture gaseous elements or particulates from ambient air. For example, without limitation, gaseous elements or particulates may include carbon dioxide (CO₂), nitrogen (N₂), oxygen (O₂), sulfur dioxide (SO₂), ammonia (NH₃), methane (CH₄), volatile organic compounds (VOCs), or inert gases such as argon (Ar), neon (Ne), and helium (He). In one or more embodiments, one or more airborne element capture material 116 may include a combination of gaseous and particulate capture materials that are used in series or parallel within the chamber 100. In one or more embodiments, one or more airborne element capture material 116 may be arranged in removable or replaceable cartridges.

In one or more embodiments, one or more airborne element capture material 116 may be configured to capture through physical adsorption, chemical adsorption, physical absorption, chemical absorption, or electrochemical reaction processes. “Adsorption” or the process of “adsorbing,” for the purpose of this disclosures, is a process in which molecules, ions, or atoms stick to a surface of another molecule through weak Van der Waals forces and/or chemical bonds. In one or more embodiments, adsorption may be contrasted with absorption, wherein absorption includes a process in which molecules penetrate the material “Electrochemical reaction process,” for the purpose of this disclosure, is a process in which electron transfer reactions are used to drive the selective separation, removal, or conversion of one or more gaseous or airborne species from a mixture.

In one or more embodiments, one or more airborne element capture material 116 may be configured to capture using adsorption-based materials, including but not limited to activated carbon, zeolites, metal-organic frameworks (MOFs), or silica gels. In one or more embodiments, one or more airborne element capture material 116 may capture gas molecules via van der Waals forces or ion-exchange interactions. In one or more embodiments, one or more airborne element capture material 116 may be configured to capture using chemical adsorption, wherein reactive materials such as amine-functionalized polymers or lithium hydroxide chemically bind to target gases like carbon dioxide or acidic vapors.

In one or more embodiments, one or more airborne element capture material 116 may be configured to capture using physical absorption based materials, including but not limited to ionic liquids, silicone oils, or perfluorinated solvents. In one or more embodiments, one or more airborne element capture material 116 may capture gas via chemical absorption based materials, including but not limited to, aqueous amine solutions, hydroxide-based sorbents (e.g., sodium hydroxide, potassium hydroxide), or amine-functionalized polymers chemically react with gases such as such as CO₂, H₂S, or NOₓ to form stable ionic or covalent products.

In one or more embodiments, one or more airborne element capture material 116 may be configured to capture through electrochemical capture techniques. In one or more embodiments, electrochemical cells, membranes, or redox-active materials may be integrated within chamber 100 to remove gases such as CO₂ or NOₓ using applied voltage or current. For example, without limitation, electrochemical capture materials may include solid-state electrochemical scrubbers or ion-selective membrane.

In one or more embodiments, one or more airborne element capture material 116 may be configured to remove particulate matter from the air. Such particulate matter may include, but are not limited to, dust, pollen, smoke, spores, bacteria, viruses, or other bioaerosols. In one or more embodiments, one or more airborne element capture material 116 may include polymer filters, HEPA (high-efficiency particulate air) filters, nonwoven fabric meshes, or conductive nanofiber mats.

Still referring to FIG. 1, an element of one or more airborne element capture material 116 may have a shape, such as, for example, a planar sheet, a cylindrical tube, and/or the like. In one or more embodiments, the shape of one or more airborne element capture material 116 may include at least a fin. For the purposes of this disclosure, a “fin” is a flattened projection from a body. fin can act to maximize surface area for the purposes of adsorption, absorption, heat exchange, or the like. In one or more embodiments, at least a fin may include, but not limited to, straight fins, annular fins, radial fins, and pin fins. In one or more embodiments, at least a fin may include copper and stainless steel, brazing techniques, and surface treatments that are employed to improve durability and thermal efficiency. In one or more embodiments, at least a fin may provide structural support within chamber 100 that can endure mechanical and thermal stresses under vacuum conditions.

In one or more embodiments, one or more airborne element capture material 116 may be made of thermally conductive materials disposed within the chamber 100. In one or more embodiments, the thermally conductive materials may be at least a fin. In one or more embodiments, thermally conductive material may contain physical properties capable of heat transfer. For example, and without limitation, thermally conductive material may include metals with high heat transfer coefficients in order to modify a temperature of one or more airborne element capture material 116. Thermally conductive material is said to have “thermally conductive properties” as described in this disclosure if it contains the ability to conduct heat. In one or more embodiments, at least a fin made of thermally conductive material may include a thermal conductivity of 10 (W/m·K) or greater. In one or more embodiments, thermal conductive properties may include aluminum, copper, stainless steel, silver, graphite, metals, and/or the like. In one or more embodiments, thermally conductive material is covered by one or more airborne element capture material 116 configured to capture airborne elements within functional temperature range.

In one or more embodiments, at least a fin may be configured in a first direction. In one or more embodiments, the first direction may correspond to a transverse orientation within chamber 100, wherein at least a fin may extend laterally across the interior 108 volume of chamber 100 from one side wall to an opposing side wall. In one or more embodiments, at least a fin may be stacked in the vertical direction (e.g., along the height or depth of the chamber 100), forming a layered or columnar arrangement. In one or more embodiments, at least a fin may be spaced apart from each other at regular or irregular intervals between adjacent fins. In one or more embodiments, at least a fin may be closely stacked with minimal spacing to maximize packing density or surface area contact. In one or more embodiments, at least a fin may be supported by one or more structural supports, rails, or hollow structural sections that run orthogonal to the first direction. In one or more embodiments, at least a fin may be rigidly fixed in chamber 100 or removably or adjustably mounted to allow for variation in spacing, alignment, or replacement. In one or more embodiments, at least a fin may have uniform or variable thicknesses, curved or angled profiles. Fins or other structures may be arranged into any lattice having any transverse cross-sectional cell form including a lattice of triangular, quadrilateral, hexagonal, or other polygonal forms. Cross-sectional cell form may alternatively or additionally include any combination of polygonal and/or curved forms. Transverse cross-section may have the form of any tessellation or tiling, including without limitation regular tiling in which all cells have the same form, such as a regular triangular, rectangular, or hexagonal tessellation, a semi-regular tessellation, a Pythagorean tiling, a periodic tiling having regular repeating patterns of combinations of shapes, a vertex-transitive tiling, an edge-to-edge tiling, a normal tiling, a monohedral tiling, an isohedral or anisohedral tiling, and/or any tiling that matches the above definitions but for irregularities introduced by manufacturing, insertion of tubes or other passages, interruption by walls of chamber, or the like. Cross-sectional form may include some regular or repeating patterns designed for structural strength interspersed or otherwise combined with other patterns designed to maximize surface area and/or airflow; for instance, a triangular lattice may have hexagonal or circular forms interspersed within it, to gain the structural strength of triangular bracing while otherwise augmenting surface area. Cross-sectional form may alternatively or additionally vary along the length of chamber, with different lattice structures in different sections and/or a lattice structure that varies in shape and/or structural strength or other characteristics along a longitudinal axis.

In one or more embodiments, at least a fin may be configured in a first direction to provide structural support to counteract atmospheric forces. In one or more embodiments, at least a fin may collectively form a self-supporting internal framework that maintains the structural integrity of chamber 100. In one or more embodiments, at least a fin may define the internal shape and contribute to cham overall rigidity. In one or more embodiments, at least a fin may be designed to withstand a range of atmospheric pressure conditions. For example, without limitation, atmospheric pressure conditions may include standard room pressure, reduced pressure environment created by at least a vacuum pump 140 during airborne element capture operations, and rapid transitions from one state to another. In one or more embodiments, at least a fin may be configured to distribute the mechanical stress evenly across the interior 108 of chamber 100.

With continued reference to FIG. 1, the first element of the one or more airborne element capture material may include at least a fin made of thermally conductive material disposed within the vacuum chamber and the at least a fin is covered by an adsorbent material configured to absorb airborne element and the at least a fin is configured in the first direction which provides structural support as the at least a fin fills the vacuum chamber transversely and counteracts atmospheric forces as the at least a fin fills the vacuum chamber transversely. In an embodiment, the at least a fin may include an aluminum plate having a thickness of 2 mm to 10 mm and extending across a rectangular vacuum chamber, wherein the aluminum plate is coated with an amine-functionalized sorbent configured to capture carbon dioxide from ambient air. In a non-limiting example, the at least a fin may include a copper sheet with a thermally sprayed layer of zeolite material applied to opposing surfaces, wherein the copper sheet facilitates rapid heat transfer during thermal cycling and the zeolite material adsorbs carbon dioxide, water vapor, or other gaseous components. For example, without limitation, the at least a fin may include a stainless steel lattice structure coated with activated carbon, metal-organic frameworks, silica gel, and the like, wherein the lattice structure spans a transverse dimension of the vacuum chamber and engages an exterior wall under vacuum conditions to resist inward deformation and distribute structural loads. As used in this disclosure, "transverse dimension" is a spatial extent of a structure measured across a width of a chamber in a direction that is perpendicular to a primary longitudinal axis of the chamber. In an embodiment, the transverse dimension may correspond to a distance between opposing side walls of a vacuum chamber, wherein a fin extends across the transverse dimension from one side wall to the other. In a non-limiting example, the transverse dimension may define a width or height of the chamber depending on orientation, such that internal components span across that dimension to provide structural engagement with the exterior wall. For example, without limitation, the transverse dimension may vary along a length of the chamber in non-uniform geometries, including rectangular, cylindrical, or polygonal cross-sections, and the like.

With continued reference to FIG. 1, chamber 100 is configured to have an element of one or more structural sections 120 disposed within chamber 100. In a non-limiting example, chamber 100 may include one or more structural sections 120 disposed within chamber 100. As used in this disclosure, a “structural section” is a structural element configured to provide support, spacing, or flow-directing functionality within the chamber. In an embodiment, the structural section may include a hollow cross-sectional profile. In an embodiment, have a solid cross-sectional profile. In one or more embodiments, the cross section of one or more structural sections 120 may be circular, rectangular, square, or other polygonal or curved geometries. In one or more embodiments one or more structural sections 120 may be suited for structural support or fluid flow management. In one or more embodiments, one or more structural sections 120 may be configured from materials including but not limited to stainless steel, aluminum, titanium, copper, or galvanized steel. In one or more embodiments, one or more structural sections 120 may be made of plastic or polymeric materials, including but not limited to high-density polyethylene (HDPE), polyvinyl chloride (PVC), acrylonitrile butadiene styrene (ABS), polypropylene (PP), or polycarbonate (PC). In one or more embodiments, one or more structural sections 120 may serve as support elements, flow conduits, or mounting structures for one or more airborne element capture material 116. In one or more embodiments, one or more structural sections 120 may be made of thermally conductive materials. In one or more embodiments, thermal conductive properties may include aluminum, copper, stainless steel, silver, graphite, metals, and/or the like. In one or more embodiments, thermal conductive properties may be configured to conduct heat via material conduction and internal fluid flow. For example, without limitation, a working fluid may flow through the interior 108 of one or more structural sections 120 and conduct heat transfer along the length of the chamber 100. In one or more embodiments, one or more structural sections 120 with a solid cross-sectional profile may be configured to conduct steam of heated gases to chamber 100 to facilitate processes associated with airborne element capture. For example, without limitation, steam may be routed through or along solid cross-sectional profile of one or more structural sections 120 in a thermal contact with airborne element capture material 116 to activate or regenerate the airborne element capture material 116. In one or more embodiments, cross-sectional profile of one or more structural sections 120 may be heated externally or internally via embedded resistive elements to sustain elevated temperature for capturing or releasing airborne elements.

In one or more embodiments, one or more structural sections 120 may be configured in a second direction. In one or more embodiments, second direction may correspond to vertical orientation within chamber 100, wherein one or more structural sections 120 may extend longitudinally across the interior 108 volume of chamber 100 from one side wall to an opposing side wall. In one or more embodiments, one or more structural sections 120 may be spaced apart or tightly packed in the vertical direction. In one or more embodiments, one or more structural sections 120 may be positioned adjacent to one or more airborne element capture material 116. In one or more embodiments, one or more structural sections 120 may be arranged in an orthogonal direction relative to one or more airborne element capture material 116, such that the orthogonal layout may enhance both thermal performance and structural stability of chamber 100. In one or more embodiments, the second direction may correspond to horizontal direction within chamber 100, wherein one or more structural sections 120 may extend laterally across the top and bottom of chamber 100. In one or more embodiments, one or more structural sections 120 in a horizontal orientation may be disposed near the top and bottom of chamber 100 without transversing the interior 108 volume. In one or more embodiments, one or more structural sections 120 may be configured in a similar or larger diameter in horizontal type relative to the vertical type. In one or more embodiments, one or more structural sections 120 in the horizontal type may function as additional structural or thermal conduits.

In one or more embodiments, one or more structural sections 120 may be configured in a second direction to provide structural support to counteract atmospheric forces. In one or more embodiments, one or more structural sections 120 may collectively form a self-supporting internal framework that maintains the structural integrity of chamber 100. In one or more embodiments, one or more structural sections 120 may define the internal shape and contribute to cham overall rigidity. In one or more embodiments, one or more structural sections 120 may be designed to withstand a range of atmospheric pressure conditions. For example, without limitation, atmospheric pressure conditions may include standard room pressure, reduced pressure environment created by at least a vacuum pump 140 during airborne element capture operations, and rapid transitions from one state to another. In one or more embodiments, one or more structural sections 120 may be configured to distribute the mechanical stress evenly across the interior 108 of chamber 100.

In one or more embodiments, one or more airborne element capture material 116 and one or more structural sections 120 may be arranged in an orthogonal orientation relative to one another within chamber 100. The combined configuration of these elements may provide enhanced structural support. In one or more embodiments, one or more airborne element capture material 116 and one or more structural sections 120 may maintain chamber 100 integrity under a variety of pressure conditions, including but not limited to atmospheric pressure, pressure conditions under vacuum, and transition of pressure conditions from one vacuum operation state to another. In one or more embodiments, one or more airborne element capture material 116 and one or more structural sections 120 may define the internal framework of chamber 100.

With continued reference to FIG. 1, chamber 100 may include a temperature control system 144. In one or more embodiments, a temperature control system 144 may include a thermal source responsible for regulating a temperature within chamber 100. A “thermal source,” as used in this disclosure, is a component that provides or removes heat energy. In an embodiment, the thermal source may act to heat or cool other elements of a system. In one or more embodiments, thermal source may include a heating element, such as an electric resistance heater, and/or a cooling element, such as a thermoelectric cooler or a compressive cooler. In one or more embodiments, temperature control system 144 may include a plurality of thermal sources, such as a first thermal source including a first type of heating and/or cooling element and a second thermal source including a second type of heating and/or cooling element. In one or more embodiments, a second thermal source may be included to supplement heat when a first thermal source is insufficient to maintain a desired temperature. A first and/or second thermal source may include at least a heating element, such as an electric resistance heater, and/or a cooling element, such as a thermoelectric cooler or a compressive cooler. In one or more embodiments, temperature control system 144 may include an automatic temperature control system 144 wherein both a first thermal source and a second thermal source are used. In one or more embodiments, the temperature control system 144 may include a heat exchanger 148. A “heat exchanger 148” for the purpose of this disclosure is a system configured to transfer heat between a heat source and/or sink and a fluid. For example, without limitation, a heat exchanger 148 may include a device that transfers heat from a hot liquid, such as water to air and airborne elementscaptured in the chamber 100. In one or more embodiments, a fluid may absorb heat from heat exchanger 148 and thereby cause the fluid to be heated. In one or more embodiments, a heat exchanger 148 may include a solid barrier, wherein a heated fluid may transfer heat to a solid barrier, and non-heated fluid may receive the heat from the solid barrier. In one or more embodiments, a heat exchanger 148 may contact a surface of one or more airborne element capture materials 116 and/or at least a fin, wherein a heated fluid may contact a surface of one or more airborne element capture material 116 and transfer heat to one or more airborne element capture material 116. In one or more embodiments, a heat exchanger 148 may heat gas in a chamber 100 by applying heat to one or more carbon capture material. In one or more embodiments, one or more airborne element capture material 116 may have a higher thermal conductivity, wherein one or more airborne element capture material 116 may be capable of conducting heat. In one or more embodiments, in a heat exchanger 148, heat moves through a solid barrier, such as through or around tubular piping, wherein the heat exchanger 148 may transfer heat onto one or more carbon capture material. In one or more embodiments, air captured in a chamber 100 may travel through an inner surface of one or more carbon capture material, wherein a heat exchanger 148 may contact an outer surface of one or more airborne element capture material 116 and apply heat to one or more carbon capture material. In one or more embodiments, a heat exchanger 148 may include a heat pump configured to heat a fluid. In one or more embodiments, a heat pump may facilitate movement of a heated fluid through piping and/or channels. In one or more embodiments, piping and/or channels may contact one or more carbon capture material. In one or more embodiments, a heat exchanger 148 may engage in a temperature swing adsorption (TSA) process wherein heat applied to one or more airborne element capture material 116 may cause airborne element to detach from the one or more airborne element capture material 116. In one or more embodiments, a heat exchanger 148 may contact at least a fin within chamber 100, and the heat exchanger 148 may apply heat to at least a fin and thereby apply heat to chamber 100. In one or more embodiments, heated fluid may be iteratively recirculated through a heat pump to apply additional heat to heated fluid wherein heated fluid may transfer heat to chamber 100. In one or more embodiments, heat exchanger 148 may provide heat through a conduction process. In one or more embodiments, a conduction process may be a process by which heat transfers through a solid material from a hotter region to a cooler region without the movement of the material itself. For example, without limitation, a heat exchanger 148 may transfer heat through one or more airborne element capture material 116 and/or a material separating heat exchanger 148 and one or more airborne element capture material 116. In one or more embodiments, a heated fluid may heat a thermally conductive material wherein the heat may be transferred to one or more airborne element capture material 116. In one or more embodiments, in shell-and-tube or plate heat exchanges, hot and cold fluids may be separated by a solid metal barrier. In one or more embodiments, in thermal swing adsorption (TSA), heat exchange may warm up one or more airborne element capture material 116, for example, but not limited to zeolite, MOFs, and amines, to release captured CO2.

In one or more embodiments, the fluid of heat exchanger 148 may be configured to provide a change in temperature to chamber 100 through the element of one or more structural sections 120 to facilitate capture and/or release of one or more airborne elements. In one or more embodiments, one or more structural sections 120 may be configured to allow the fluid from the heat exchanger 148 to pass at an adjustable flow rate, enabling controller thermal transfer. In one or more embodiments, the fluid from heat exchanger 148 may transfer heat to one or more structural sections 120, and one or more structural sections 120 may transfer heat to one or more airborne element capture material 116. In one or more embodiments, one or more structural sections 120 may be constructed to withstand thermal stress associated with temperature fluctuation resulting from fluid circulation. In one or more embodiments, fluid from heat exchanger 148 may conduct a first mode temperature to one or more structural sections 120 to facilitate capture of one or more airborne elements. In one or more embodiments, fluid from heat exchanger 148 may conduct a first mode temperature to one or more structural sections 120 to facilitate release of one or more airborne elements. In one or more embodiments, fluid from heat exchanger 148 may conduct a first mode temperature to one or more structural sections 120 to facilitate removal of water vapor in chamber 100 before airborne element capture.

In one or more embodiments, heat exchanger 148 may alternatively or additionally be configured as an electrically powered heating system to provide a change in temperature to chamber 100 through the element of one or more structural sections 120 to facilitate capture and/or release of one or more airborne elements. In one or more embodiments, one or more structural sections 120 may include embedded or externally mounted electrical heating elements, which may be selectively activated to achieve precise thermal control. In one or more embodiments, the electrical heating system may be operably coupled to a temperature control system 144 to adjust heating intensity based on real-time temperature readings. In one or more embodiments, heat generated by the electrical heating system may be transferred from one or more structural sections 120 to one or more airborne element capture materials 116. In one or more embodiments, one or more structural sections 120 may be constructed from or coated with thermally conductive materials to optimize heat transfer efficiency. In one or more embodiments, electrical heating may be used to achieve a first mode temperature for facilitating airborne element capture and/or a second mode temperature for facilitating airborne element release or regeneration. In one or more embodiments, the electrical heating system may also be configured to remove residual water vapor or precondition chamber 100 before airborne element capture.

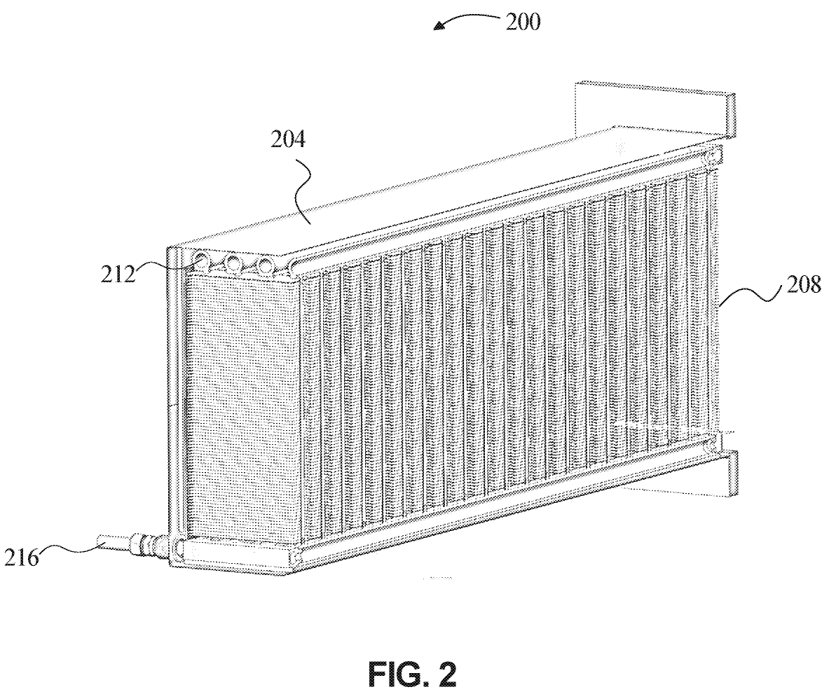

Referring now to FIG. 2, an exemplary embodiment of a cross-sectional view of a carbon capture chamber 200 is illustrated. Without limitation, the carbon capture chamber 200 may be the same or substantially similar to the vacuum chamber 100. In one non-limiting example, vacuum chamber 100 may be configured as an outer chamber, and carbon capture chamber 200 may be disposed within, integrated with, or fluidly coupled to vacuum chamber 100. In one or more embodiments, vacuum chamber 100 may provide a controlled pressure environment, such as a reduced-pressure or vacuum condition, while carbon capture chamber 200 may be configured to receive airflow and facilitate adsorption and/or absorption of carbon dioxide from the airflow. In one or more embodiments, air may be directed into carbon capture chamber 200 from vacuum chamber 100, or vice versa, depending on system configuration and operating conditions. In one or more embodiments, carbon capture chamber 200 may be structurally supported by or enclosed within vacuum chamber 100, such that vacuum chamber 100 provides an external housing and environmental control, while carbon capture chamber 200 provides a functional region dedicated to carbon capture. In this way, vacuum chamber 100 and carbon capture chamber 200 may operate cooperatively, with vacuum chamber 100 enhancing the efficiency of carbon capture performed within carbon capture chamber 200. In one or more embodiments, carbon capture chamber 200 may also be referred to as a “carbon capture system.” In one or more embodiments, carbon capture chamber 200 may serve as an active carbon capture system, wherein carbon capture chamber 200 may be configured to adsorb and/or absorb carbon dioxide. In one or more embodiments, a gas such as air is blown through the carbon capture chamber 200. In one or more embodiments, carbon capture chamber 200 may include one or more walls 204 that are used to provide a structure to carbon capture chamber 200. In one or more embodiments, one or more walls 204 may ensure that carbon capture chamber 200 is capable of providing a sealed environment from the atmosphere. In one or more embodiments, one or more walls 204 may provide structural rigidity such that carbon capture chamber 200 does not collapse or buckle under negative pressure. In one or more embodiments, carbon capture chamber 200 may be similar to that of a container, wherein one or more walls 204 may provide the structure of the container. In one or more embodiments, one or more walls 204 may be made of a structurally rigid material such as aluminum, copper, a metal, a metal alloy, and/or the like. In one or more embodiments, one or more walls 204 may be made of thermally conductive materials in order to facilitate a heat transfer between an inside of carbon capture chamber 200 and outside of carbon capture chamber 200.

The carbon capture chamber 200 may include a plurality of fins 208 made of a thermally conductive material, such as thermally conductive material as described in this disclosure. In one or more embodiments, the plurality of fins 208 may include and/or be included in a material body as described in reference to at least FIG. 1. In one or more embodiments, the plurality of fins may include a thermally conductive material such as any material as described in this disclosure which contains thermal properties capable of transferring heat. In one or more embodiments, the thermally conductive material may be covered and/or coated with an adsorbent and/or absorbent material that carbon dioxide will attach to at a low temperature. In one or more embodiments, the thermally conductive material may provide for efficient heat transfer between the adsorbent and/or absorbent material and the thermally conductive material in order to facilitate an adsorption or desorption process. In one or more embodiments, once the carbon dioxide is adsorbed and/or absorbed to the adsorbent and/or absorbent material, the air may be sucked out of carbon capture chamber 200 using a vacuum system such as any vacuum system as described in this disclosure. The vacuum system may expel any air within carbon capture chamber 200 while leaving the carbon dioxide, which remains adsorbed and/or absorbed to the adsorbent and/or absorbent material. In one or more embodiments, the plurality of fins may be heated up in order to facilitate carbon dioxide release. In one or more embodiments, air may transfer through a plurality of fins 208, wherein carbon dioxide may adsorb and/or absorb to a surface of fins during the transfer. In one or more embodiments, a plurality of fins 208 may include adsorbent and/or absorbent material as described in reference to at least FIG. 1. In one or more embodiments, a plurality of fins 208 may provide for increased surface area between air passing through carbon capture chamber 200. In one or more embodiments, a plurality of fins 208 may include substantially planar surface in which air passes through and adsorbs and/or absorbs to a surface of the plurality of fins. In one or more embodiments, a plurality of fins 208 may include a plurality of sheets stacked above one another and spaced evenly to allow for air to pass through the sheets. In one or more embodiments, a plurality of fins 208 may include a structurally rigid material such as metal or metal alloy in order to contain a pressure within carbon capture chamber 200. In one or more embodiments, a plurality of fins 208 may include substantially planar sheets that allow for maximum surface area contact between air and an adsorbent and/or absorbent coating on a plurality of fins 208. In one or more embodiments, heating of the plurality of fins will allow for heat to transfer to adsorbent and/or absorbent material and thereby cause increased molecular activity, which will result in the release of carbon dioxide from adsorbent and/or absorbent material. In one or more embodiments, a plurality of fins 208 may be heated by pumping hot water through pipes thermally connected to the plurality of fins. This process may release the carbon dioxide into the surrounding atmosphere of the carbon capture chamber 200. In one or more embodiments, a second vacuum is then used to expel carbon dioxide in the carbon capture chamber 200. In one or more embodiments, following the release of carbon dioxide, the carbon dioxide may be suspended in a gaseous format, where a vacuum may be used to retrieve the gaseous format from the chamber. In one or more embodiments, following removal of carbon dioxide, the plurality of fins may be cooled (e.g., using cold water and/or a heat exchanger as described in this disclosure) and carbon capture chamber 200 is repressurized and/or reopened in order to accept new air and restart the carbonic cycle.

With continued reference to FIG. 2, in one or more embodiments, a plurality of fins 208 may extend laterally across carbon capture chamber 200 from an inlet to an outlet. In one or more embodiments, the inlet may be defined as the location at which air and/or gas enters carbon capture chamber 200, wherein outlet may be defined as the location at which air or gas leaves carbon capture chamber 200.

With continued reference to FIG. 2, a system as described in reference to FIG. 1 may utilize multiple chambers, permitting some carbon capture chamber 200 to run adsorption and/or absorption cycles while others are desorbing (pulling vacuum). Such a process would allow continuous airflow. In addition, such a process would allow for individual modules (also referred to as “individual carbon capture chamber”) to be taken offline for repair or swapped with replacements while the system continues to operate. Downstream, the carbon dioxide may be further purified by removing water vapor and cooled to form liquid or pumped into pressurized tanks. The whole system can be integrated into a datacenter that uses air (at least partially) to cool servers/computers, or any other setup where air has to be moved through for other reasons, such as, but not limited to, an apartment or office buildings with active ventilation/HVAC systems. In one or more embodiments, the system described herein may be implemented and/or integrated into data centers and/or existing devices that utilize airflow in order to remove carbon dioxide from the air flowing through said devices.

With continued reference to FIG. 2, carbon capture chamber 200 may include at least a tube with first direction 212. In one or more embodiments, at least a tube with first direction 212 may be disposed horizontally at top or bottom of carbon capture chamber 200. In one or more embodiments, at least a tube with first direction 212 may extend transversely across the top and bottom of carbon capture chamber 200 from one side wall to an opposing side wall. In one or more embodiments, at least a tube with first direction 212 may be arranged orthogonally relative to a plurality of fins 208. In one or more embodiments, at least a tube with first direction 212 may be disposed near the top and bottom of carbon capture chamber 200 without transversing the interior volume of the carbon capture chamber 200. In one or more embodiments, at least a tube with first direction 212 may be configured to enhance the thermal performance and/or structural stability of carbon capture chamber 200. In one or more embodiments, at least a tube with first direction 212 may provide structural support under various pressure levels associated with vacuum operation. In one or more embodiments, at least a tube with first direction 212 may serve as a component of heating element and/or heat exchanger as described in this disclosure. In one or more embodiments, heated glass and/or fluids may flow through at least a tube with first direction 212 in order to provide heat to carbon capture chamber 200. In one or more embodiments, carbon capture chamber 200 may be heated through conduction, wherein heat from liquids such as water may heat at least a tube with first direction 212 and heat from tubes may be transferred to a plurality of fins 208. In one or more embodiments, at least a tube with first direction 212 and a plurality of fins 208 may contain a thermally conductive material that allows for heat to transfer between at least a tube with first direction 212 and a plurality of fins 208. In one or more embodiments, at least a tube with first direction 212 may be configured to hold a cooled liquid as well, wherein the cooled liquid may absorb heat from carbon capture chamber 200 and a plurality of fins 208. In one or more embodiments, liquids may flow within at least a tube with first direction 212 through the use of a cooling pump and/or a heating pump.

With continued reference to FIG. 2, it may be the case that vacuum chamber require a significant degree of structural strength, or they risk implosion due to pressure differences caused by the use of a vacuum. Such as an implosion may be mitigated through the use of thick sidewalls, reinforcing ribs, and/or particular (e.g., cylindrical) shapes. In one or more embodiments, carbon capture chamber 200 may include a plurality of fins 208 and/or at least a tube with first direction 212 that can both facilitate in the carbonic cycle and simultaneously provide structural support to carbon capture chamber 200. In one or more embodiments, carbon capture chamber 200 may be designed with much thinner walls that will “suck onto” the plurality of fins/the plurality of tubes when the vacuum is pulled and be held there against collapse(transverse) or buckling (longitudinal). In one or more embodiments, the use of a plurality of fins 208 and at least a tube with first direction 212 to provide structural support will ensure that the only place where thicker material is needed is at the ends (e.g., the inlet and outlet) of the carbon capture chamber 200. This can work on any transverse cross-sectional shape, but is especially useful for rectangular cross-sections, which are cheap to make and easy to fill: better for cost-effective and reliable mass production. The walls could be made from the sort of plastic used for vacuum sealing but will probably be metal or a heat-resistant hard plastic.

With continued reference to FIG. 2, both the plurality of fins and the plurality of tubes can provide support for the walls of carbon capture chamber 200. In one or more embodiments, the plurality of fins may provide structural support from side to side, while the plurality of tubes provides structural support perpendicularly to the plurality of fins and from top to bottom. As the vacuum chamber gets bigger and bigger, the walls have to get increasingly thicker. In one or more embodiments, use of a plurality of fins 208 and at least a tube with first direction 212 as structural support for carbon capture chamber 200 may allow for an increase in size to carbon capture chamber 200 without decreasing structural rigidity of carbon capture chamber 200. In one or more embodiments, a vacuum chamber without internals, such as a plurality of fins 208 and ribs, may collapse when increased in size due to structural deficiencies. In one or more embodiments, a plurality of fins 208 and at least a tube with first direction 212 may perform the thermal exchange/adsorption process while providing structural rigidity to carbon capture chamber 200 as well. In one or more embodiments, a plurality of fins 208 may fill the chamber transversely, while at least a tube with first direction 212 fill carbon capture chamber 200 vertically, to provide (in a first direction and a second direction) structural integrity against negative pressure.

With continued reference to FIG. 2, carbon capture chamber 200 may include a heat exchanger and/or heating component 216 as described in reference to at least FIG. 1. In one or more embodiments, heating component 216 may include a heat transfer structure. The heat transfer structure may also serve as a structural member contacting the external walls and taking the loads (e.g., by preventing buckling). In one or more embodiments, the heat transfer structure may include any material that is thermally conductive. This may include any material as described in this disclosure. In one or more embodiments, thermally conductive material may further include copper or aluminum. Rails could be anything (aluminum is easy to machine, or stainless, or plastic (able to take high temperature- like CPVC, nylon, PEEK; 92°C or as low as 50°C to 60°C). Exterior walls of carbon capture chamber 200 could be stainless, aluminum, or even plastic (could be quite weak, as thin as a plastic bag, such as a high-tensile plastic bag). In one or more embodiments, heating components 216 may include and/or be fluidly connected to at least a tube with first direction 212, wherein a fluid from heating component 216 may flow through tubes.

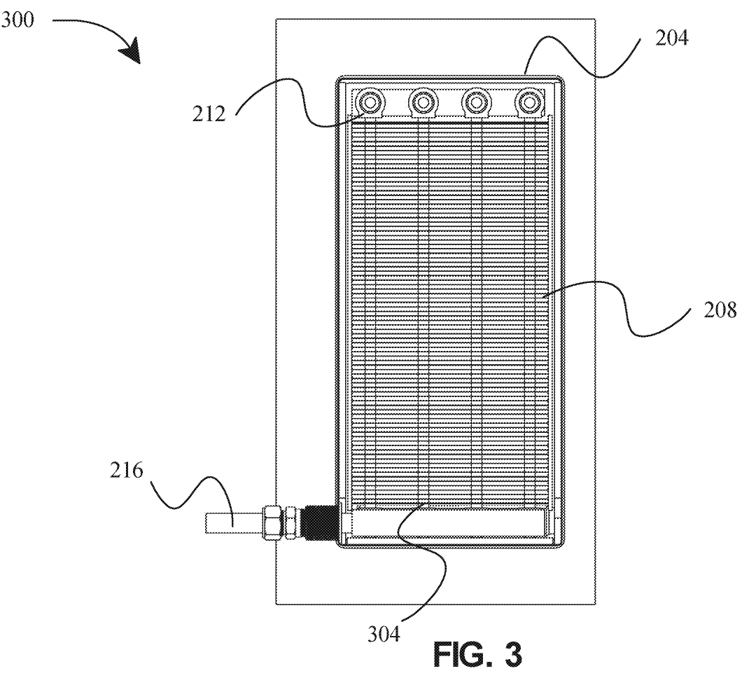

Referring now to FIG. 3, an exemplary embodiment of a front view of carbon capture chamber 300 is illustrated. In one or more embodiments, carbon capture chamber 300 may be configured to perform substantially similar carbon capture functions as carbon capture chamber 200, while being shown from a different perspective or including additional or alternative structural features. In one or more embodiments, carbon capture chamber 300 may be disposed within, integrated with, or fluidly coupled to vacuum chamber 100, consistent with the relationship described above. In one or more embodiments, carbon capture chamber 300 may also be referred to as a “carbon capture system.” In one or more embodiments, carbon capture chamber 300 may serve as an active carbon capture system, wherein carbon capture chamber 300 may be configured to adsorb and/or absorb carbon dioxide. In one or more embodiments, a gas such as air is blown through the carbon capture chamber 300. In one or more embodiments, carbon capture chamber 300 may include one or more walls 204 that are used to provide a structure to carbon capture chamber 300. In one or more embodiments, one or more walls 204 may ensure that carbon capture chamber 300 is capable of providing a sealed environment from the atmosphere. In one or more embodiments, one or more walls 204 may provide structural rigidity such that carbon capture chamber 300 does not collapse or buckle under negative pressure. In one or more embodiments, carbon capture chamber 300 may be similar to that of a container, wherein one or more walls 204 may provide the structure of the container. In one or more embodiments, one or more walls 204 may be made of a structurally rigid material such as aluminum, copper, a metal, a metal alloy, and/or the like. In one or more embodiments, one or more walls 204 may be made of thermally conductive materials in order to facilitate a heat transfer between an inside of carbon capture chamber 300 and outside of carbon capture chamber 300.

The carbon capture chamber 300 may include a plurality of fins 208 made of a thermally conductive material, such as thermally conductive material as described in this disclosure. In one or more embodiments, the plurality of fins 208 may include and/or be included in a material body as described in reference to at least FIG. 1. In one or more embodiments, the plurality of fins may include a thermally conductive material such as any material as described in this disclosure which contains thermal properties capable of transferring heat. In one or more embodiments, the thermally conductive material may be covered and/or coated with an adsorbent and/or absorbent material that carbon dioxide will attach to at a low temperature. In one or more embodiments, the thermally conductive material may provide for efficient heat transfer between the adsorbent and/or absorbent material and the thermally conductive material in order to facilitate an adsorption or desorption process. In one or more embodiments, once the carbon dioxide is adsorbed and/or absorbed to the adsorbent and/or absorbent material, the air may be sucked out of carbon capture chamber 300 using a vacuum system such as any vacuum system as described in this disclosure. The vacuum system may expel any air within carbon capture chamber 300 while leaving the carbon dioxide which remains adsorbed and/or absorbed to the adsorbent and/or absorbent material. In one or more embodiments, the plurality of fins may be heated up in order to facilitate carbon dioxide release. In one or more embodiments, air may transfer through a plurality of fins 208, wherein carbon dioxide may adsorb and/or absorb to a surface of fins during the transfer. In one or more embodiments, a plurality of fins 208 may include adsorbent and/or absorbent material as described in reference to at least FIG. 1. In one or more embodiments, a plurality of fins 208 may provide for increased surface area between air passing through carbon capture chamber 300. In one or more embodiments, a plurality of fins 208 may include substantially planar surface in which air passes through and adsorbs and/or absorbs to a surface of the plurality of fins. In one or more embodiments, a plurality of fins 208 may include a plurality of sheets stacked above one another and spaced evenly to allow for air to pass through the sheets. In one or more embodiments, a plurality of fins 208 may include a structurally rigid material such as metal or metal alloy in order to contain a pressure within carbon capture chamber 300. In one or more embodiments, a plurality of fins 208 may include substantially planar sheets that allow for maximum surface area contact between air and an adsorbent and/or absorbent coating on a plurality of fins 208. In one or more embodiments, heating of the plurality of fins will allow for heat to transfer to adsorbent and/or absorbent material and thereby cause increased molecular activity, which will result in the release of carbon dioxide from adsorbent and/or absorbent material. In one or more embodiments, a plurality of fins 208 may be heated by pumping hot water through pipes thermally connected to the plurality of fins. This process may release the carbon dioxide into the surrounding atmosphere of the carbon capture chamber 300. In one or more embodiments, a second vacuum is then used to expel the carbon dioxide in the carbon capture chamber 300. In one or more embodiments, following the release of carbon dioxide, the carbon dioxide may be suspended in a gaseous format, where a vacuum may be used to retrieve the gaseous format from the chamber. In one or more embodiment, following removal of carbon dioxide, the plurality of fins may be cooled (e.g., using cold water and/or a heat exchanger as described in this disclosure) and carbon capture chamber 300 is repressurized and/or reopened in order to accept new air and restart the carbonic cycle.

With continued reference to FIG. 3, in one or more embodiments, a plurality of fins 208 may extend laterally across carbon capture chamber 300 from an inlet to an outlet. In one or more embodiments, the inlet may be defined as the location at which air and/or gas enters carbon capture chamber 300, wherein outlet may be defined as the location at which air or gas leaves carbon capture chamber 300.

With continued reference to FIG. 3, a system as described in reference to FIG. 1 may utilize multiple chambers, permitting some carbon capture chamber 300 to run adsorption and/or absorption cycles while others are desorbing (pulling vacuum). Such a process would allow continuous airflow. In addition, such as process would allow for individual modules (also referred to as “individual carbon capture chamber”) to be taken offline for repair or swapped with replacements while the system continues to operate. Downstream, the carbon dioxide may be further purified by removing water vapor and the cooled to form liquid or pumped into pressurized tanks. The whole system can be integrated into a datacenter that uses air (at least partially) to cool servers/computers, or any other setup where air has to be moved through for other reasons, such as, but not limited to, an apartment or office buildings with active ventilation/HVAC systems. In one or more embodiments, the system described herein may be implemented and/or integrated into data centers and/or existing devices that utilize airflow in order to remove carbon dioxide from the air flowing through said devices.

With continued reference to FIG. 3, carbon capture chamber 300 may include at least a tube with first direction 212. In one or more embodiments, at least a tube with first direction 212 may be disposed horizontally at top or bottom of carbon capture chamber 300. In one or more embodiments, at least a tube with first direction 212 may extend transversely across the top and bottom of carbon capture chamber 300 from one side wall to an opposing side wall. In one or more embodiments, at least a tube with first direction 212 may be arranged orthogonally relative to a plurality of fins 208. In one or more embodiments, at least a tube with first direction 212 may be disposed near the top and bottom of carbon capture chamber 300 without transversing the interior volume of the carbon capture chamber 300. In one or more embodiments, at least a tube with first direction 212 may be configured to enhance the thermal performance and/or structural stability of carbon capture chamber 300. In one or more embodiments, at least a tube with first direction 212 may provide structural support under various pressure level associated with vacuum operation. In one or more embodiments, at least a tube with first direction 212 may serve as a component of heating element and/or heat exchanger as described in this disclosure. In one or more embodiments, heated glass and/or fluids may flow through at least a tube with first direction 212 in order to provide heat to carbon capture chamber 300. In one or more embodiments, carbon capture chamber 300 may be heated through conduction, wherein heat from liquids such as water may heat at least a tube with first direction 212 and heat from tubes may be transferred to a plurality of fins 208. In one or more embodiments, at least a tube with first direction 212 and a plurality of fins 208 may contain a thermally conductive material that allows for heat to transfer between at least a tube with first direction 212 and a plurality of fins 208. In one or more embodiments, at least a tube with first direction 212 may be configured to hold a cooled liquid as well, wherein the cooled liquid may absorb heat from carbon capture chamber 300 and a plurality of fins 208. In one or more embodiments, liquids may flow within at least a tube with first direction 212 through the use of a cooling pump and/or a heating pump.

With continued reference to FIG. 3, carbon capture chamber 300 may include at least a tube with second direction 304. In one or more embodiments, at least a tube with second direction 304 may be disposed vertically within carbon capture chamber 300. In one or more embodiments, at least a tube with second direction 304 may extend longitudinally across the interior volume of carbon capture chamber 300 from one side wall to an opposing side wall. In one or more embodiments, at least a tube with second direction 304 may be spaced apart or tightly packed in the vertical direction. In one or more embodiments, at least a tube with second direction 304 may be positioned adjacent to a plurality of fins 208. In one or more embodiments, at least a tube with second direction 304 may have a similar to smaller diameter compared to at least a tube with first direction 212. In one or more embodiments, at least a tube with second direction 304 may function as a thermal conduit and provides structural support to carbon capture chamber 300. In one or more embodiments, at least a tube with second direction 304 may provide structural support under various pressure level associated with vacuum operation. In one or more embodiments, carbon capture chamber 300 may be heated through conduction, wherein heat from liquids such as water may heat at least a tube with second direction 304 and heat from tubes may be transferred to a plurality of fins 208. In one or more embodiments, at least a tube with second direction 304 and a plurality of fins 208 may contain a thermally conductive material that allows for heat to transfer between at least a tube with second direction 304 and a plurality of fins 208. In one or more embodiments, at least a tube with second direction 304 may be configured to hold a cooled liquid as well, wherein the cooled liquid may absorb heat from carbon capture chamber 300 and a plurality of fins 208. In one or more embodiments, liquids may flow within at least a tube with second direction 304 through the use of a cooling pump and/or a heating pump.

With continued reference to FIG. 3, it may be the case that vacuum chamber require a significant degree of structural strength, or they risk implosion due to pressure differences caused by the use of a vacuum. Such as implosion may be mitigated through the use of thick sidewalls, reinforcing ribs, and/or particular “carbon capture system.” In one or more embodiments, carbon capture chamber 300 may be designed with much thinner walls that will “suck onto” the plurality of fins/the plurality of tubes when the vacuum is pulled and be held there against collapse(transverse) or buckling (longitudinal). In one or more embodiments, the use of a plurality of fins 208 and a plurality of tube to provide structural support will ensure that the only place where thicker material is needed is at the ends (e.g., the inlet and outlet) of the carbon capture chamber 300. This can work on any transverse cross-sectional shape, but is especially useful for rectangular cross-sections, which are cheap to make and easy to fill: better for cost-effective and reliable mass production. The walls could be made from the sort of plastic used for vacuum sealing but will probably be metal or a heat-resistant hard plastic.

With continued reference to FIG. 3, both the plurality of fins and the plurality of tubes can provide support for the walls of carbon capture chamber 300. In one or more embodiments, the plurality of fins may provide structural support from side to side, while the plurality of tubes provides structural support perpendicularly to the plurality of fins and from top to bottom. As the vacuum chamber gets bigger and bigger, the walls have to get increasingly thicker. In one or more embodiments, use of a plurality of fins 208 and at least a tube with second direction 304 as structural support for carbon capture chamber 300 may allow for an increase in size to carbon capture chamber 300 without decreasing structural rigidity of carbon capture chamber 300. In one or more embodiments, a vacuum chamber without internals such as a plurality of fins 208 and ribs may collapse when increased in size due to structural deficiencies. In one or more embodiments, a plurality of fins 208 and at least a tube with second direction 304 may perform the thermal exchange/adsorption process while providing structural rigidity to carbon capture chamber 300 as well. In one or more embodiments, a plurality of fins 208 may fill the chamber transversely, while at least a tube with second direction 304 fill carbon capture chamber 300 vertically, to provide (in a first direction and a second direction) structural integrity against negative pressure.

With continued reference to FIG. 3, carbon capture chamber 300 may include a heat exchanger and/or heating component 216 as described in reference to at least FIG. 1. In one or more embodiments, heating component 216 may include a heat transfer structure. The heat transfer structure may also serve as a structural member contacting the external walls and taking the loads (e.g., by preventing buckling). In one or more embodiments, the heat transfer structure may include any material that is thermally conductive. This may include any material as described in this disclosure. In one or more embodiments, thermally conductive material may further include copper or aluminum. Rails could be anything (aluminum is easy to machine, or stainless, or plastic (able to take high temperature- like CPVC, nylon, PEEK; 92°C or as low as 50°C to 60°C). Exterior walls of carbon capture chamber 300 could be stainless, aluminum, or even plastic (could be quite weak, as thin as plastic bag such as a high-tensile plastic bag). In one or more embodiments, heating components 216 may include and/or be fluidly connected to a plurality of tube, wherein a fluid from heating component 216 may flow through tubes.

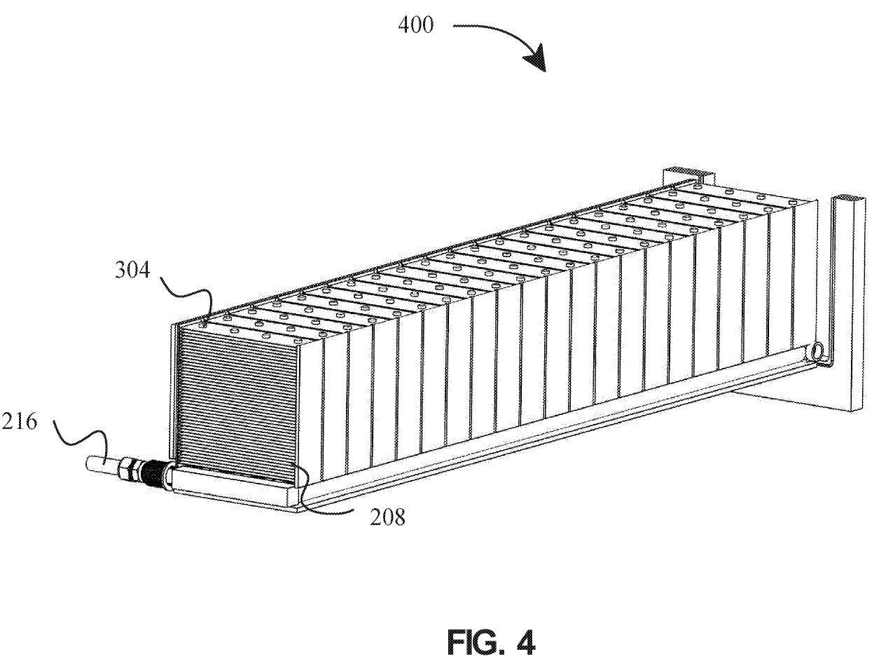

Referring now to FIG. 4, an exemplary embodiment of cross-sectional view taken along a horizontal plane of a carbon capture chamber 400 is illustrated. Without limitation, carbon capture chamber 400 may correspond to, be the same as, or be a further embodiment of carbon capture chamber 200 and/or carbon capture chamber 300 described above. In one or more embodiments, carbon capture chamber 400 may be configured to perform substantially similar carbon capture functions, while illustrating internal features and flow paths not visible in the external views. In one or more embodiments, carbon capture chamber 400 may be disposed within, integrated with, or fluidly coupled to vacuum chamber 100, consistent with the relationship described above. In one or more embodiments, carbon capture chamber 400 may also be referred as a “carbon capture system.” In one or more embodiments, carbon capture chamber 200 may serve as an active carbon capture system, wherein carbon capture chamber 400 may be configured to adsorb and/or absorb carbon dioxide. In one or more embodiments, a gas such as air is blown through the carbon capture chamber 200. In one or more embodiments, one or more walls 204 may ensure that carbon capture chamber 200 is capable of providing a sealed environment from the atmosphere.

The carbon capture chamber 400 may include a plurality of fins 208 made of a thermally conductive material, such as thermally conductive material as described in this disclosure. In one or more embodiments, the plurality of fins 208 may include and/or be included in a material body as described in reference to at least FIG. 1. In one or more embodiments, the plurality of fins may include a thermally conductive material such as any material as described in this disclosure which contains thermal properties capable of transferring heat. In one or more embodiments, the thermally conductive material may be covered and/or coated with an adsorbent and/or absorbent material that carbon dioxide will attach to at a low temperature. In one or more embodiments, the thermally conductive material may provide for efficient heat transfer between the adsorbent and/or absorbent material and the thermally conductive material in order to facilitate an adsorption or desorption process. In one or more embodiments, once the carbon dioxide is adsorbed and/or absorbed to the adsorbent and/or absorbent material, the air may be sucked out of carbon capture chamber 200 using a vacuum system such as any vacuum system as described in this disclosure. The vacuum system may expel any air within carbon capture chamber 400 while leaving the carbon dioxide which remains adsorbed and/or absorbed to the adsorbent and/or absorbent material. In one or more embodiments, the plurality of fins may be heated up in order to facilitate carbon dioxide release. In one or more embodiments, air may transfer through a plurality of fins 208, wherein carbon dioxide may adsorb and/or absorb to a surface of fins during the transfer. In one or more embodiments, a plurality of fins 208 may include adsorbent and/or absorbent material as described in reference to at least FIG. 1. In one or more embodiments, a plurality of fins 208 may provide for increased surface area between air passing through carbon capture chamber 400. In one or more embodiments, a plurality of fins 208 may include substantially planar surface in which air passes through and adsorbs and/or absorbs to a surface of the plurality of fins. In one or more embodiments, a plurality of fins 208 may include a plurality of sheets stacked above one another and spaced evenly to allow for air to pass through the sheets. In one or more embodiments, a plurality of fins 208 may include a structurally rigid material such as metal or metal alloy in order to contain a pressure within carbon capture chamber 400. In one or more embodiments, a plurality of fins 208 may include substantially planar sheets that allow for maximum surface area contact between air and an adsorbent and/or absorbent coating on a plurality of fins 208. In one or more embodiments, heating of the plurality of fins will allow for heat to transfer to adsorbent and/or absorbent material and thereby cause increased molecular activity which will result in the release of carbon dioxide from adsorbent and/or absorbent material. In one or more embodiments, a plurality of fins 208 may be heated by pumping hot water through pipes thermally connected to the plurality of fins. This process may release the carbon dioxide into the surrounding atmosphere of the carbon capture chamber 400. In one or more embodiments, a second vacuum is then used to expel the carbon dioxide in the carbon capture chamber 400. In one or more embodiments, following the release of carbon dioxide, the carbon dioxide may be suspended in a gaseous format, where a vacuum may be used to retrieve the gaseous format from the chamber. In one or more embodiment, following removal of carbon dioxide, the plurality of fins may be cooled (e.g., using cold water and/or a heat exchanger as described in this disclosure) and carbon capture chamber 200 is repressurized and/or reopened in order to accept new air and restart the carbonic cycle.

With continued reference to FIG. 4, in one or more embodiments, a plurality of fins 208 may extend laterally across carbon capture chamber 400 from an inlet to an outlet. In one or more embodiments, the inlet may be defined as the location at which air and/or gas enters carbon capture chamber 400, wherein outlet may be defined as the location at which air or gas leaves carbon capture chamber 400.

With continued reference to FIG. 4, a system as described in reference to FIG. 1 may utilize multiple chambers permitting some carbon capture chamber 400 to run adsorption and/or absorption cycles while others are desorbing (pulling vacuum). Such a process would allow continuous airflow. In addition, such as process would allow for individual modules (also referred to as “individual carbon capture chamber”) to be taken offline for repair or swapped with replacements while the system continues to operate. Downstream, the carbon dioxide may be further purified by removing water vapor and the cooled to form liquid or pumped into pressurized tanks. The whole system can be integrated into a datacenter that uses air (at least partially) to cool servers/computers, or any other setup where air has to be moved through for other reasons, such as, but not limited to, an apartment or office buildings with active ventilation/HVAC systems. In one or more embodiments, the system described herein may be implemented and/or integrated into data centers and/or existing devices that utilize airflow in order to remove carbon dioxide from the air flowing through said devices.

With continued reference to FIG. 4, carbon capture chamber 400 may include at least a tube with second direction 304. In one or more embodiments, at least a tube with second direction 304 may be disposed of vertically within carbon capture chamber 400. In one or more embodiments, at least a tube with second direction 304 may extend longitudinally across the interior volume of carbon capture chamber 400 from one side wall to an opposing side wall. In one or more embodiments, at least a tube with second direction 304 may be spaced apart or tightly packed in the vertical direction. In one or more embodiments, at least a tube with second direction 304 may be positioned adjacent to a plurality of fins 208. In one or more embodiments, at least a tube with second direction 304 may have a similar to smaller diameter compared to at least a tube with first direction 212. In one or more embodiments, at least a tube with second direction 304 may function as a thermal conduit and provides structural support to carbon capture chamber 400. In one or more embodiments, at least a tube with second direction 304 may provide structural support under various pressure level associated with vacuum operation. In one or more embodiments, carbon capture chamber 400 may be heated through conduction, wherein heat from liquids such as water may heat at least a tube with second direction 304 and heat from tubes may be transferred to a plurality of fins 208. In one or more embodiments, at least a tube with second direction 304 and a plurality of fins 208 may contain a thermally conductive material that allows for heat to transfer between at least a tube with second direction 304 and a plurality of fins 208. In one or more embodiments, at least a tube with second direction 304 may be configured to hold a cooled liquid as well, wherein the cooled liquid may absorb heat from carbon capture chamber 400 and a plurality of fins 208. In one or more embodiments, liquids may flow within at least a tube with second direction 304 through the use of a cooling pump and/or a heating pump.

With continued reference to FIG. 4, it may be the case that vacuum chamber requires a significant degree of structural strength, or they risk implosion due to pressure differences caused by the use of a vacuum. Such as an implosion may be mitigated through the use of thick sidewalls, reinforcing ribs, and/or particular (e.g., cylindrical) shapes. In one or more embodiments, carbon capture chamber 400 may include a plurality of fins 208, at least a tube with first direction 212 and/or at least a tube with second direction 304, each configured to facilitate in the carbonic cycle and simultaneously provide structural support to carbon capture chamber 400. In one or more embodiments, carbon capture chamber 400 may be designed with much thinner walls that will “suck onto” the plurality of fins/the plurality of tubes when the vacuum is pulled and be held there against collapse(transverse) or buckling (longitudinal). In one or more embodiments, the use of a plurality of fins 208 and a plurality of tube to provide structural support will ensure that the only place where thicker material is needed is at the ends (e.g., the inlet and outlet) of the carbon capture chamber 400. This can work on any transverse cross-sectional shape, but is especially useful for rectangular cross-sections, which are cheap to make and easy to fill: better for cost-effective and reliable mass production. The walls could be made from the sort of plastic used for vacuum sealing but will probably be metal or a heat-resistant hard plastic.

With continued reference to FIG. 4, both the plurality of fins and the plurality of tubes can provide support for the walls of carbon capture chamber 400. In one or more embodiments, use of a plurality of fins 208 and at least a tube with second direction 304 as structural support for carbon capture chamber 400 may allow for an increase in size to carbon capture chamber 400 without decreasing structural rigidity of carbon capture chamber 400. In one or more embodiments, a vacuum chamber without internals such as a plurality of fins 208 and ribs may collapse when increased in size due to structural deficiencies. In one or more embodiments, a plurality of fins 208 and at least a tube with second direction 304 may perform the thermal exchange/adsorption process while providing structural rigidity to carbon capture chamber 400 as well. In one or more embodiments, a plurality of fins 208 may fill the chamber transversely, while at least a tube with second direction 304 fill carbon capture chamber 400 vertically, to provide (in a first direction and a second direction) structural integrity against negative pressure.

With continued reference to FIG. 4, carbon capture chamber 400 may include a heat exchanger and/or heating component 216 as described in reference to at least FIG. 1. In one or more embodiments, heating component 216 may include a heat transfer structure. The heat transfer structure may also serve as a structural member contacting the external walls and taking the loads (e.g., by preventing buckling). In one or more embodiments, the heat transfer structure may include any material that is thermally conductive. This may include any material as described in this disclosure. In one or more embodiments, thermally conductive material may further include copper or aluminum. Rails could be anything (aluminum is easy to machine, or stainless, or plastic (able to take high temperature- like CPVC, nylon, PEEK; 92°C or as low as 50°C to 60°C). Exterior walls of carbon capture chamber 400 could be stainless, aluminum, or even plastic (could be quite weak, as thin as plastic bag such as a high-tensile plastic bag). In one or more embodiments, heating components 216 may include and/or be fluidly connected to a plurality of tube, wherein a fluid from heating component 216 may flow through tubes.

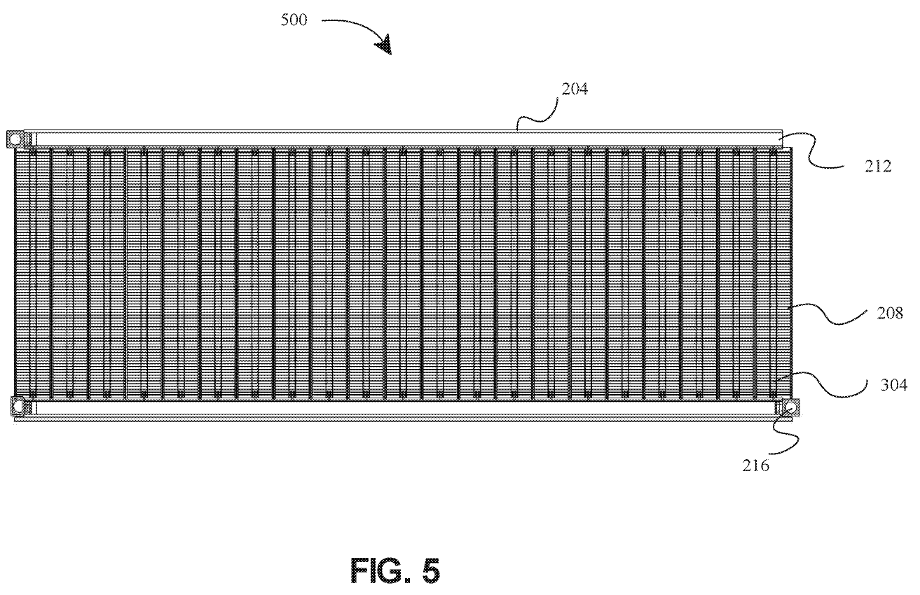

Referring now to FIG. 5, an exemplary embodiment of cross-sectional view taken along a vertical plane of a carbon capture chamber 500 is illustrated. In one or more embodiments, carbon capture chamber 500 may also be referred as a “carbon capture system.” In one or more embodiments, carbon capture chamber 500 may serve as an active carbon capture system, wherein carbon capture chamber 500 may be configured to adsorb and/or absorb carbon dioxide. In one or more embodiments, a gas such as air is blown through the carbon capture chamber 500. In one or more embodiments, carbon capture chamber 500 may include one or more walls 204 that are used to provide a structure to carbon capture chamber 500. In one or more embodiments, one or more walls 204 may ensure that carbon capture chamber 500 is capable of providing a sealed environment from the atmosphere. In one or more embodiments, one or more walls 204 may provide structural rigidity such that carbon capture chamber 500 does not collapse or buckle under negative pressure. In one or more embodiments, carbon capture chamber 500 may be similar to that of a container, wherein one or more walls 204 may provide the structure of the container. In one or more embodiments, one or more walls 204 may be made of a structurally rigid material such as aluminum, copper, a metal, a metal alloy, and/or the like. In one or more embodiments, one or more walls 204 may be made of thermally conductive materials in order to facilitate a heat transfer between an inside of carbon capture chamber 500 and outside of carbon capture chamber 500.

The carbon capture chamber 500 may include a plurality of fins 208 made of a thermally conductive material, such as thermally conductive material as described in this disclosure. In one or more embodiments, the plurality of fins 208 may include and/or be included in a material body as described in reference to at least FIG. 1. In one or more embodiments, the plurality of fins may include a thermally conductive material such as any material as described in this disclosure which contains thermal properties capable of transferring heat. In one or more embodiments, the thermally conductive material may be covered and/or coated with an adsorbent and/or absorbent material that carbon dioxide will attach to at a low temperature. In one or more embodiments, the thermally conductive material may provide for efficient heat transfer between the adsorbent and/or absorbent material and the thermally conductive material in order to facilitate an adsorption or desorption process. In one or more embodiments, once the carbon dioxide is adsorbed and/or absorbed to the adsorbent and/or absorbent material, the air may be sucked out of carbon capture chamber 500 using a vacuum system such as any vacuum system as described in this disclosure. The vacuum system may expel any air within carbon capture chamber 500 while leaving the carbon dioxide which remains adsorbed and/or absorbed to the adsorbent and/or absorbent material. In one or more embodiments, the plurality of fins may be heated up in order to facilitate carbon dioxide release. In one or more embodiments, air may transfer through a plurality of fins 208, wherein carbon dioxide may adsorb and/or absorb to a surface of fins during the transfer. In one or more embodiments, a plurality of fins 208 may include adsorbent and/or absorbent material as described in reference to at least FIG. 1. In one or more embodiments, a plurality of fins 208 may provide for increased surface area between air passing through carbon capture chamber 500. In one or more embodiments, a plurality of fins 208 may include substantially planar surface in which air passes through and adsorbs and/or absorbs to a surface of the plurality of fins. In one or more embodiments, a plurality of fins 208 may include a plurality of sheets stacked above one another and spaced evenly to allow for air to pass through the sheets. In one or more embodiments, a plurality of fins 208 may include a structurally rigid material such as metal or metal alloy in order to contain a pressure within carbon capture chamber 500. In one or more embodiments, a plurality of fins 208 may include substantially planar sheets that allow for maximum surface area contact between air and an adsorbent and/or absorbent coating on a plurality of fins 208. In one or more embodiments, heating of the plurality of fins will allow for heat to transfer to adsorbent and/or absorbent material and thereby cause increased molecular activity which will result in the release of carbon dioxide from adsorbent and/or absorbent material. In one or more embodiments, a plurality of fins 208 may be heated by pumping hot water through pipes thermally connected to the plurality of fins. This process may release the carbon dioxide into the surrounding atmosphere of the carbon capture chamber 500. In one or more embodiments, a second vacuum is then used to expel the carbon dioxide in the carbon capture chamber 500. In one or more embodiments, following the release of carbon dioxide, the carbon dioxide may be suspended in a gaseous format, where a vacuum may be used to retrieve the gaseous format from the chamber. In one or more embodiment, following removal of carbon dioxide, the plurality of fins may be cooled (e.g., using cold water and/or a heat exchanger as described in this disclosure) and carbon capture chamber 500 is repressurized and/or reopened in order to accept new air and restart the carbonic cycle.

With continued reference to FIG. 5, in one or more embodiments, a plurality of fins 208 may extend laterally across carbon capture chamber 500 from an inlet to an outlet. In one or more embodiments, the inlet may be defined as the location at which air and/or gas enters carbon capture chamber 500, wherein outlet may be defined as the location at which air or gas leaves carbon capture chamber 500.

With continued reference to FIG. 5, a system as described in reference to FIG. 1 may utilize multiple chambers permitting some carbon capture chamber 500 to run adsorption and/or absorption cycles while others are desorbing (pulling vacuum). Such a process would allow continuous airflow. In addition, such as process would allow for individual modules (also referred to as “individual carbon capture chamber”) to be taken offline for repair or swapped with replacements while the system continues to operate. Downstream, the carbon dioxide may be further purified by removing water vapor and the cooled to form liquid or pumped into pressurized tanks. The whole system can be integrated into a datacenter that uses air (at least partially) to cool servers/computers, or any other setup where air has to be moved through for other reasons, such as, but not limited to, an apartment or office buildings with active ventilation/HVAC systems. In one or more embodiments, the system described herein may be implemented and/or integrated into data centers and/or existing devices that utilize airflow in order to remove carbon dioxide from the air flowing through said devices.

With continued reference to FIG. 5, carbon capture chamber 500 may include at least a tube with first direction 212. In one or more embodiments, at least a tube with first direction 212 may be disposed horizontally at top or bottom of carbon capture chamber 500. In one or more embodiments, at least a tube with first direction 212 may extend transversely across the top and bottom of carbon capture chamber 500 from one side wall to an opposing side wall. In one or more embodiments, at least a tube with first direction 212 may be arranged orthogonally relative to a plurality of fins 208. In one or more embodiments, at least a tube with first direction 212 may be disposed near the top and bottom of carbon capture chamber 500 without transversing the interior volume of the carbon capture chamber 500. In one or more embodiments, at least a tube with first direction 212 may be configured to enhance the thermal performance and/or structural stability of carbon capture chamber 500. In one or more embodiments, at least a tube with first direction 212 may provide structural support under various pressure level associated with vacuum operation. In one or more embodiments, at least a tube with first direction 212 may serve as a component of heating element and/or heat exchanger as described in this disclosure. In one or more embodiments, heated glass and/or fluids may flow through at least a tube with first direction 212 in order to provide heat to carbon capture chamber 500. In one or more embodiments, carbon capture chamber 500 may be heated through conduction, wherein heat from liquids such as water may heat at least a tube with first direction 212 and heat from tubes may be transferred to a plurality of fins 208. In one or more embodiments, at least a tube with first direction 212 and a plurality of fins 208 may contain a thermally conductive material that allows for heat to transfer between at least a tube with first direction 212 and a plurality of fins 208. In one or more embodiments, at least a tube with first direction 212 may be configured to hold a cooled liquid as well, wherein the cooled liquid may absorb heat from carbon capture chamber 500 and a plurality of fins 208. In one or more embodiments, liquids may flow within at least a tube with first direction 212 through the use of a cooling pump and/or a heating pump.

With continued reference to FIG. 5, it may be the case that vacuum chamber requires a significant degree of structural strength, or they risk implosion due to pressure differences caused by the use of a vacuum. Such as an implosion may be mitigated through the use of thick sidewalls, reinforcing ribs, and/or particular (e.g., cylindrical) shapes. In one or more embodiments, carbon capture chamber 400 may include a plurality of fins 208, at least a tube with first direction 212 and/or at least a tube with second direction 304, each configured to facilitate in the carbonic cycle and simultaneously provide structural support to carbon capture chamber 500. In one or more embodiments, carbon capture chamber 500 may be designed with much thinner walls that will “suck onto” the plurality of fins/the plurality of tubes when the vacuum is pulled and be held there against collapse(transverse) or buckling (longitudinal). In one or more embodiments, the use of a plurality of fins 208 and a plurality of tube to provide structural support will ensure that the only place where thicker material is needed is on the ends (e.g., the inlet and outlet) of the carbon capture chamber 500. This can work on any transverse cross-sectional shape, but is especially useful for rectangular cross-sections, which are cheap to make and easy to fill: better for cost-effective and reliable mass production. The walls could be made from the sort of plastic used for vacuum sealing but will probably be metal or a heat-resistant hard plastic.

With continued reference to FIG. 5, both the plurality of fins and the plurality of tubes can provide support for the walls of carbon capture chamber 500. In one or more embodiments, the plurality of fins may provide structural support from side to side, while the plurality of tubes provides structural support perpendicularly to the plurality of fins and from top to bottom. As the vacuum chamber gets bigger and bigger, the walls have to get increasingly thicker. In one or more embodiments, use of a plurality of fins 208 and at least a tube with first direction 212 as structural support for carbon capture chamber 500 may allow for an increase in size to carbon capture chamber 500 without decreasing structural rigidity of carbon capture chamber 500. In one or more embodiments, a vacuum chamber without internals such as a plurality of fins 208 and ribs may collapse when increased in size due to structural deficiencies. In one or more embodiments, a plurality of fins 208 and at least a tube with first direction 212 may perform the thermal exchange/adsorption process while providing structural rigidity to carbon capture chamber 500 as well. In one or more embodiments, a plurality of fins 208 may fill the chamber transversely, while at least a tube with first direction 212 fill carbon capture chamber 500 vertically, to provide (in a first direction and a second direction) structural integrity against negative pressure.

With continued reference to FIG. 5, carbon capture chamber 500 may include a heat exchanger and/or heating component 216 as described in reference to at least FIG. 1. In one or more embodiments, heating component 216 may include a heat transfer structure. The heat transfer structure may also serve as a structural member contacting the external walls and taking the loads (e.g., by preventing buckling). In one or more embodiments, the heat transfer structure may include any material that is thermally conductive. This may include any material as described in this disclosure. In one or more embodiments, thermally conductive material may further include copper or aluminum. Rails could be anything (aluminum is easy to machine, or stainless, or plastic (able to take high temperature- like CPVC, nylon, PEEK; 92°C or as low as 50°C to 60°C). Exterior walls of carbon capture chamber 500 could be stainless, aluminum, or even plastic (could be quite weak, as thin as plastic bag such as a high-tensile plastic bag). In one or more embodiments, heating components 216 may include and/or be fluidly connected to a plurality of tube, wherein a fluid from heating component 216 may flow through tubes.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

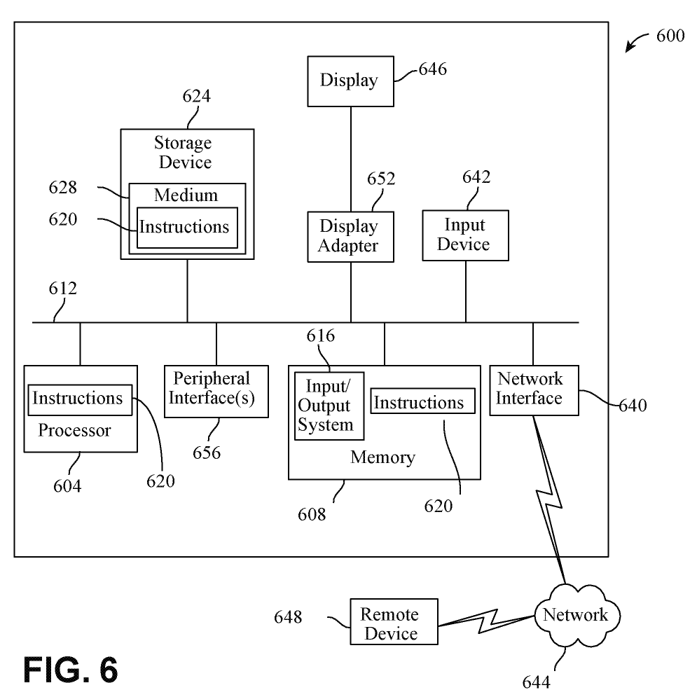

FIG. 6 shows a diagrammatic representation of one embodiment of a computing device in the exemplary form of a computer system 600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 600 includes a processor 604 and a memory 608 that communicate with each other, and with other components, via a bus 612. Bus 612 may include any of several types of bus structures including, but not limited to, a memory bus, a memory controller, a peripheral bus, a local bus, and any combinations thereof, using any of a variety of bus architectures.

Processor 604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 604 may be organized according to Von Neumann and/or Harvard architecture as a non-limiting example. Processor 604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 608 may include various components (e.g., machine-readable media) including, but not limited to, a random-access memory component, a read only component, and any combinations thereof. In one example, a basic input/output system 616 (BIOS), including basic routines that help to transfer information between elements within computer system 600, such as during start-up, may be stored in memory 608. Memory 608 may also include (e.g., stored on one or more machine-readable media) instructions (e.g., software) 620 embodying any one or more of the aspects and/or methodologies of the present disclosure. In another example, memory 608 may further include any number of program modules including, but not limited to, an operating system, one or more application programs, other program modules, program data, and any combinations thereof.

Computer system 600 may also include a storage device 624. Examples of a storage device (e.g., storage device 624) include, but are not limited to, a hard disk drive, a magnetic disk drive, an optical disc drive in combination with an optical medium, a solid-state memory device, and any combinations thereof. Storage device 624 may be connected to bus 612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 624 (or one or more components thereof) may be removably interfaced with computer system 600 (e.g., via an external port connector (not shown)). Particularly, storage device 624 and an associated machine-readable medium 628 may provide nonvolatile and/or volatile storage of machine-readable instructions, data structures, program modules, and/or other data for computer system 600. In one example, software 620 may reside, completely or partially, within machine-readable medium 628. In another example, software 620 may reside, completely or partially, within processor 604.

Computer system 600 may also include an input device 642. In one example, a user of computer system 600 may enter commands and/or other information into computer system 600 via input device 642. Examples of an input device 642 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 642 may be interfaced to bus 612 via any of a variety of interfaces (not shown) including, but not limited to, a serial interface, a parallel interface, a game port, a USB interface, a FIREWIRE interface, a direct interface to bus 612, and any combinations thereof. Input device 642 may include a touch screen interface that may be a part of or separate from display 646, discussed further below. Input device 642 may be utilized as a user selection device for selecting one or more graphical representations in a graphical interface as described above.

A user may also input commands and/or other information to computer system 600 via storage device 624 (e.g., a removable disk drive, a flash drive, etc.) and/or network interface device 640. A network interface device, such as network interface device 640, may be utilized for connecting computer system 600 to one or more of a variety of networks, such as network 644, and one or more remote devices 648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 644, may employ a wired and/or a wireless mode of communication. In general, any network topology may be used. Information (e.g., data, software 620, etc.) may be communicated to and/or from computer system 600 via network interface device 640.

Computer system 600 may further include a video display adapter 652 for communicating a displayable image to a display device, such as display 646. Examples of a display device include, but are not limited to, a liquid crystal display (LCD), a cathode ray tube (CRT), a plasma display, a light emitting diode (LED) display, and any combinations thereof. Display adapter 652 and display 646 may be utilized in combination with processor 604 to provide graphical representations of aspects of the present disclosure. In addition to a display device, computer system 600 may include one or more other peripheral output devices including, but not limited to, an audio sPEEKer, a printer, and any combinations thereof. Such peripheral output devices may be connected to bus 612 via a peripheral interface 656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A vacuum chamber with dual-purpose internal structure, the vacuum chamber comprising:
at least an exterior wall defining an interior of the vacuum chamber;
a selectively sealable air intake coupled to the exterior wall and in fluid communication with the interior of the vacuum chamber;
a selectively sealable air exhaust coupled to the exterior wall and in fluid communication with the interior of the vacuum chamber;
at least a vacuum pump in communication with the vacuum chamber;
a first element of one or more airborne element capture materials disposed within the vacuum chamber, wherein the first element fills the vacuum chamber in a first direction; and
a second element of one or more hollow structural sections disposed within the vacuum chamber, wherein the second element fills the vacuum chamber in a second direction.

2. The vacuum chamber of claim 1, wherein when the vacuum pump generates vacuum conditions within the interior of the vacuum chamber, the exterior wall is configured to:
draw inward; and
engage with the first element and the second element.

3. The vacuum chamber of claim 2, wherein the first element is disposed within the interior of the vacuum chamber and extends in the first direction across a transverse dimension of the vacuum chamber such that the first element contacts the exterior wall under the vacuum conditions.

4. The vacuum chamber of claim 2, wherein the second element is disposed within the interior of the vacuum chamber and extends in the second direction different from the first direction, wherein the second element is positioned to engage the exterior wall under the vacuum conditions.

5. The vacuum chamber of claim 1, wherein the exterior wall is configured to withstand a vacuum pressure of approximately XXX within the vacuum chamber.

6. The vacuum chamber of claim 1, wherein the selectively sealable air intake comprises an intake valve configured to:
regulate an amount of air entering the vacuum chamber; and
control a direction of an inlet fluid, wherein the inlet fluid comprises a gas.

7. The vacuum chamber of claim 1, wherein the selectively sealable air exhaust comprises an outlet valve configured to control an amount of air exiting the vacuum chamber.

8. The vacuum chamber of claim 1, wherein:
the first element comprises at least a fin made of thermally conductive material disposed within the vacuum chamber;
the at least a fin is covered by an adsorbent material configured to absorb an airborne element; and
the at least a fin is configured in the first direction which:
provides structural support as the at least a fin fills the vacuum chamber transversely; and
counteracts atmospheric forces as the at least a fin fills the vacuum chamber transversely.

9. The vacuum chamber of claim 1, wherein:
the second element comprises one or more thermally conductive materials; and
the second element is configured in the second direction and fills the vacuum chamber vertically and horizontally to provide structural support to counteract atmospheric forces.

10. The vacuum chamber of claim 1, wherein the vacuum chamber further comprises a temperature control system, wherein the temperature control system is in thermal communication with the first element.

11. The vacuum chamber of claim 10, wherein the temperature control system comprises a heat exchanger configured to perform a temperature swing adsorption process by heating the first element of the one or more airborne element capture materials to cause release of one or more airborne elements.

12. The vacuum chamber of claim 10, wherein the second element further comprises embedded electrical heating elements configured to provide localized heating to the first element, wherein the electrical heating elements are operably coupled to the temperature control system that adjusts heating intensity based on real-time temperature readings.

13. The vacuum chamber of claim 1, wherein the first element and the second element are arranged in an orthogonal orientation relative to each other to form a load-distributing internal framework.

14. The vacuum chamber of claim 1, wherein the second element comprises a plurality of fluid conduits configured to transport a working fluid, wherein the working fluid is configured to transfer heat to the first element.

15. The vacuum chamber of claim 1, wherein the first element comprises a lattice structure, wherein the lattice structure comprises a hexagonal tessellation.

16. The vacuum chamber of claim 1, wherein the second element comprises a frame structure positioned along one or more edges of the vacuum chamber, wherein the frame structure is configured to transfer loads from the at least an exterior wall.

17. The vacuum chamber of claim 1, wherein the second element comprises both vertical sections and horizontal sections, wherein the vertical sections and horizontal sections collectively resist buckling in multiple directions.

18. The vacuum chamber of claim 1, wherein the first element comprises removable modules configured to be inserted into and removed from the vacuum chamber.

19. The vacuum chamber of claim 1, wherein the vacuum chamber is configured as a modular unit within a system comprising a plurality of vacuum chambers, wherein at least one vacuum chamber performs adsorption while at least one other vacuum chamber performs desorption.

20. The vacuum chamber of claim 1, wherein the one or more airborne element capture materials is configured to capture carbon dioxide.
